(19) United States
(12) Patent Application Publication
(10) Pub. No.: US 2024/0269040 A1
(43) Pub. Date: Aug. 15, 2024

(54) DEVICE AND METHOD FOR ACCELERATED THAWING

(71) Applicant: BioNTech SE, Mainz (DE)

(72) Inventors: Ferdia Bates, Mainz (DE); Karina Nawrath, Mainz (DE); Christian Panhans, Lauf (DE); Marco Prehn, Mainz (DE); Ralph Krause, Dresden (DE); Christian Friebe, Dresden (DE); Moritz Kuhn, Dresden (DE); Frank Schoepe, Dresden (DE); Thomas Oppelt, Dresden (DE)

(21) Appl. No.: 18/563,738

(22) PCT Filed: May 25, 2022
(86) PCT No.: PCT/EP2022/064339

§ 371 Date: Nov. 22, 2023

(30) Foreign Application Priority Data
May 26, 2021 (EP) 21176087.1

(51) Int. Cl. A61J 1/16; A61J 1/10

(52) U.S. Cl. CPC A61J 1/16; A61J 1/10

(57) ABSTRACT

A device (100) for accelerating thawing of a content of one or a plurality of containers (160) is provided and an associated method.

### FIELD OF THE DISCLOSURE

The present disclosure relates to a device, a method and a system for thawing frozen liquid housed in a container. More particularly, the means of the disclosure can be applied to containers with medical liquids, especially biopharmaceutical liquids.

### BACKGROUND

This section is provided to illustrate the background of the disclosure. Nothing disclosed herein is admitted by the applicant to constitute prior art.

The need for freezing and then rapid thawing of frozen liquids, such as BDPs (BDP: bulk drug product), often arises in (bio)pharmaceutical manufacturing schemes, especially if they involve process steps which need to be conducted at different sites, or require the storage of the liquid.

The scheme may include manufacturing or formulating a liquid substance (bulk) at one site and transporting the liquid substance to a different site to prepare the final drug product (which is available to be purchased in the pharmacy, e.g. in a vial). It is often required to transport or store the liquid substance in frozen form. Using a frozen bulk process (involving frozen liquid substance) means that the bulk manufacturing sites need to be equipped with a process to freeze bulk and ship the frozen bulk (—60 to −80° C.) and all Fill & Finish sites (where the drug product (DP) is prepared) need to be able to receive, store and/or thaw the frozen BDPs. It has turned out that bulk production and Fill & Finish are bottleneck steps in the production process, which makes the ability to store frozen liquid (which usually has a longer shelf life than non-frozen liquid, particularly medical liquid) advantageous. As such, there is a need to propose solutions for the reduction of the thawing time (or accelerating the thawing process), preferably solutions that while doing it efficiently and fast, do not affect the integrity and efficacy of the thawed medical liquid.

### SUMMARY OF THE DISCLOSURE

It is an object of the present disclosure to provide improvements or novel features relating to thawing frozen liquid substances.

This object is achieved by subject matter defined in the independent claims. Advantageous embodiments and refinements are subject to the dependent claims or will become apparent from the remaining disclosure.

The device of the present disclosure may include a gas flow generation unit, that may force or enhance convection at the containers in the container receptacles of the container carrier. This may improve heat exchange between the gas, e.g. air, such as ambient air, in the gas flow path and the substance in the container and, hence, accelerate thawing. If, as in a preferred embodiment, the content of the containers, in addition to being exposed to the gas flow is also agitated, e.g. by moving the container unit containing the container receptacles back and forth between two end positions, during the thawing cycle, thawing can be further accelerated, and thawing time further shortened. The gas flow generation unit may improve the heat transfer between containers and environment. The agitation of the content of the containers, e.g. by the movement of the container unit, may enhance heat distribution within the containers and the liquid thawing therein. The thawing process during the operation cycle (thawing cycle) may be assisted by choosing the parameters of the container movement and/or the gas flow generation appropriately, e.g. to the particular frozen liquid which is made subject to the thawing process. However, generating the gas flow and/or moving the container unit has turned out to have the most decisive influence on accelerating the thawing.

As will become apparent from the present disclosure, the proposed device and method may provide further advantages. By utilizing the means and methods of the present disclosure, for example, more than 100 L, e.g. 160 L, of frozen liquid (a typical batch of a production process run may yield up to 160 L of liquid bulk drug product which needs to be transferred to a different site and/or stored in frozen form) distributed over a variety of containers, e.g. 15 12 L containers, such as Sartorius® Celsius FFT 12 L bags, can be thawed from −60° C. to 15° C. in a time less than or equal to one of the following values: 20 h, 18 h, 16 h, 15 h, 14 h, 13 h, 12 h, 11 h, 10 h, 9 h, 8 h.

The liquid may be a medical liquid, e.g. a pharmaceutical or biopharmaceutical liquid, Preferably, the liquid comprises an active pharmaceutical ingredient. The liquid may be Comirnaty® BDP. The liquid may comprise RNA and/or liposomes.

Features which are disclosed herein in connection with the device do also apply for the method as the device may be configured to perform the method and vice versa as the method may be performed using the device. Moreover, each claim or aspect (see below) is to be understood as disclosing the subject-matter of that claim or aspect as such, i.e. independently, without references to any one of the preceding claims or aspects, even if the claim or aspect contains such a reference.

In the following, a set of aspects is disclosed. The aspects are numbered to facilitate referencing the features of one aspect in other aspects. The aspects form part of the disclosure of the present application and could be made subject to independent and/or dependent claims irrespective of what currently is claimed in the application. We note, however, that the scope of protection is defined by the appended claims, where the following aspects do not constitute claims. The aspects are:
1. A device for thawing, preferably for accelerating the thawing of, the content of one or a plurality of containers, wherein the content comprises a frozen liquid, the device comprising:
   a container unit, the container unit comprising a container carrier, wherein the container carrier has one or more container receptacles each container receptacle being suitable to receive one container with the frozen liquid; and
   a gas flow generation unit, wherein the gas flow generation unit is operable to generate a gas flow along a gas flow path defined in the device, and wherein the device, in the region of the container carrier, is configured to define a container region of the gas flow path, wherein, in the container region, a section of the gas flow path extends along the exterior of the respective container when the respective container is arranged in the container receptacle, and wherein, preferably, the device is configured to influence the gas flow in the container region, e.g. to enhance convection at an exterior of the respective containers.
2. The device of aspect 1, wherein each container receptacle is suitable to receive one container with the frozen liquid.
3. The device of any one of the preceding aspects, wherein the container receptacles are configured to receive containers of an identical exterior structure and/or form factor.
4. The device of any one of the preceding aspects, wherein the container carrier has a plurality of container receptacles arranged above each other and/or wherein the container carrier has a plurality of container receptacles arranged beside each other.
5. The device of aspect 4, wherein the container carrier comprises a plurality of rows of container receptacles and/or a plurality of columns of container receptacles, wherein each row of container receptacles and/or each column of container receptacles comprises a plurality of container receptacles.
6. The device of aspect 5,
   wherein the number of container receptacles in the columns and/or rows is greater than or equal to: 2, 3, 4, 5.
7. The device of aspect 5 or 6,
   wherein the number of container receptacles in the columns and/or rows is less than or equal to: 10, 9, 8, 7, 6, 5.
8. The device of any one of aspects 5 to 7,
   wherein the number of container receptacles in one row is greater than or equal to 2 and less than or equal to 5, e.g. 3.
9. The device of any one of aspects 5 to 8,
   wherein the number of container receptacles in one column is greater than or equal to 2 and less than or equal to 8, e.g. 5.
10. The device of any one of the preceding aspects,
   wherein a plurality of container receptacles is integrated into a rack of the container carrier.
11. The device of aspect 10,
   wherein the container receptacles in the rack are stacked above one another in a column e.g. in one column.
12. The device of aspect 10 or 11,
   wherein the container carrier comprises a plurality of racks arranged beside each other.
13. The device of any one of the preceding aspects,
   wherein between two adjacent container receptacles, preferably any two vertically and/or laterally adjacent receptacles, one section of the gas flow path in the container region of the gas flow path is formed between the containers, when containers are arranged in the two adjacent receptacles.
14. The device of any one of the preceding aspects,
   wherein the container, preferably wherein each container, when in the container receptacle, is sandwiched between two sections of the gas flow path.
15. The device of any one of the preceding aspects,
   wherein the device comprises a chassis, and wherein the container carrier is connected to or connectable to the chassis.
16. The device of aspect 15,
   wherein the gas flow generation unit is connected, preferably fixedly connected, to the chassis.
17. The device of any one of the preceding aspects,
   wherein a main gas flow direction in the sections of the gas flow path in the container region is oriented along a main extension direction of the containers when the containers are received in the respective container receptacle.
18. The device of aspect 17,
   wherein the main extension direction is a longitudinal direction or length direction, e.g. a direction along which the container has its maximum extension or maximum length.
19. The device of any one of the preceding aspects,
   wherein, in the container region, each container is directly exposed to the gas flow along at least one section of the gas flow path, preferably to the gas flow along a plurality of sections of the gas flow path.
20. The device of any one of the preceding aspects,
   wherein the gas flow generation unit is at least one of, an arbitrarily selected plurality of, or all of:
   a motorized unit, and
   an electrically driven unit.
21. The device of any one of the preceding aspects,
   wherein the gas flow generation unit is an active flow generation unit which is operable to actively displace gas.
22. The device of any one of the preceding aspects,
   wherein the gas flow generation unit comprises one or a plurality of movable gas flow generation members, wherein, preferably, each of the gas flow generation members is operable to generate a gas flow which contributes to the total gas flow along the gas flow path.
23. The device of aspect 22,
   wherein the gas flow generation members are linearly arranged, preferably in a one dimensional arrangement in one row.
24. The device of claim 22 or aspect 23,
   wherein different gas flow generation members are assigned to different columns of container receptacles.
25. The device of any one of aspects 22 to 24,
   wherein the movable gas flow generation members are arranged to generate gas flows in parallel directions.
26. The device of any one of aspects 22 to 25,
   wherein the respective gas flow generation member comprises a fan.
27. The device of aspect 26,
   wherein the fans of the gas flow generation members are arranged such that their rotation axes are parallel.
28. The device of any one of aspects 22 to 27,
   wherein the respective gas flow generation member is configured to provide a gas displacement of greater than or equal to one of the following values: 3000 m³/h, 4000 m³/h, 4500 m³/h, 4900 m³/h, 5000 m³/h (m: meter, h: hour).
29. The device of any one of aspects 22 to 28,
   wherein the respective gas flow generation member is configured to provide a gas displacement of less than or equal to one of the following values: 7000 m³/h, 6500 m³/h, 6000 m³/h, 5500 m³/h 5000 m³/h.
30. The device of any one of the preceding aspects,
   wherein the gas flow generation unit and/or the respective gas flow generation member is configured to generate a gas flow, preferably at the gas flow generation unit or at the gas flow generation member, with a gas flow velocity of greater than or equal to one of the following values: 1.0 m/s, 1.1 m/s, 1.2 m/s, 1.3 m/s, 1.4 m/s, 1.5 m/s, 1.6 m/s, 1.7 m/s, 1.8 m/s, 1.9 m/s, 2 m/s, 2.5 m/s, 3 m/s, 3.5 m/s, 4 m/s, 4.5 m/s, 5 m/s (m: meter, s: second).
31. The device of any one of the preceding aspects,
   wherein the gas flow generation unit is configured to generate a gas flow and/or the respective gas flow generation member is configured to generate a gas flow, preferably at the gas flow generation unit or at the gas flow generation member, with a gas flow velocity of less than or equal to one of the following values: 8 m/s, 7 m/s, 6.5 m/s, 6 m/s, 5.5 m/s, 5 m/s, 4 m/s, 3.5 m/s, 3 m/s, 2.5 m/s, 2 m/s, 1.5 m/s.
32. The device of any one of the preceding claims,
   wherein the gas flow generation unit is configured to provide a total gas displacement of greater than or equal to one of the following values: 9000 m³/h, 10000 m³/h, 11000 m³/h, 12000 m³/h, 13000 m³/h, 14000 m³/h, 14500 m³/h, 15000 m³/h.
33. The device of any one of the preceding aspects,
   wherein the gas flow generation unit is configured to provide a total gas displacement of less than or equal to one of the following values: 21000 m³/h, 19500 m³/h, 18000 m³/h, 16500 m³/h, 15000 m³/h.
34. The device of any one of the preceding aspects,
   wherein the gas flow path comprises an intermediate region, which is arranged between the container region and the gas flow generation unit as seen along the gas flow path, and/or a remote region which, as seen along the gas flow path, is arranged on that side of the container region remote from the gas flow generation unit.
35. The device of aspect 34,
   wherein the gas flow generation unit is configured to displace gas towards the container region via the intermediate region, e.g. such that the gas flow direction in the gas flow path is from the gas flow generation unit via the intermediate region to the container region and/or from the container region to the remote region.
36. The device of any one of the preceding aspects,
   wherein the gas flow generation unit is configured to displace the gas along the gas flow path towards the container region in a blowing mode of operation of the gas flow generation unit.
37. The device of any one of the preceding aspects,
   wherein the device comprises one or more gas inlets and one or more gas outlets, the gas flow path extending from the gas inlets to the gas outlets and/or fluidly connecting the gas inlets and the gas outlets.
38. The device of aspect 37,
   wherein the gas outlet of the device is or the gas outlets of the device are in the remote region.
39. The device of aspect 37 or 38,
   wherein the gas inlet of the device is or the gas inlets of the device are defined by the gas flow generation unit.
40. The device of any one of the preceding aspects,
   wherein the container unit is movable relative to the chassis and/or the gas flow generation unit, e.g. movably connected to the chassis, wherein, preferably, the container unit is movable relative to the chassis and/or relative to the gas flow generation unit in at least one direction, e.g. in one direction, such as linearly.
41. The device of aspect 40,
   wherein the container unit is connected to the chassis such that movement of the container unit relative to the chassis is restricted to linear movement along a movement axis.
42. The device of aspect 41,
   wherein the container unit is movable along the movement axis in opposite directions.
43. The device of aspect 41 or 42,
   wherein the movement axis is fixed relative to the chassis and/or relative to the gas flow generation unit.
44. The device of any one of aspects 41 to 43,
   wherein the movement axis of the linear movement of the container unit is perpendicular to the gas flow path, e.g. perpendicular to the gas flow direction, in the container region or perpendicular to the main longitudinal direction of extension of the containers.
45. The device of any one of the preceding aspects,
   wherein the device comprises a motor configured to, during operation of the device, move the container unit relative to the chassis, preferably in different, e.g. in opposite, directions.
46. The device of aspect 45,
   wherein the motor is mounted to the chassis and operatively connected to the container unit, e.g. via a gear interface.
47. The device of any one of the preceding aspects,
   wherein the device is configured to move the container unit between two extreme positions relative to the chassis and/or the gas flow generation unit, e.g. in an oscillating manner.
48. The device of aspect 47,
   wherein the device is configured such that a frequency of the oscillating movement of the container unit between the two extreme positions is less than or equal to one of the following values: 1.5 Hz, 1.3 Hz, 1.0 Hz, 0.9 Hz, 0.8 Hz, 0.75 Hz, 0.7 Hz, 0.65 Hz, 0.6 Hz, 0.55 Hz, 0.5 Hz, 0.4 Hz, 0.35 Hz (Hz=Hertz).
49. The device of aspect 47 or 48,
   wherein the device is configured such that a frequency of the oscillating movement of the container unit between the two extreme positions is greater than or equal to one of the following values: 0.01 Hz, 0.1 Hz, 0.2 Hz, 0.3 Hz, 0.4 Hz, 0.5 Hz, 0.6 Hz, 0.7 Hz, 0.75 Hz.
50. The device of any one of the preceding aspects,
   wherein the container unit comprises a container gas duct, the container gas duct delimiting the gas flow path laterally or circumferentially in the container region.
51. The device of aspect 50,
   wherein, in the container region, an exterior surface of a container in cooperation with the inner wall of the container gas duct delimits a section of the gas flow path.
52. The device of aspect 50 or 51,
   wherein the container gas duct is fixed with respect to the container carrier, and wherein, preferably, the container gas duct and the container carrier are fixed to a common container unit base.
53. The device of any one of aspects 50 to 52,
   wherein the container receptacles are and/or the container carrier is laterally surrounded by the container gas duct.
54. The device of any one of the preceding aspects,
   wherein, in the region of the container unit, the gas flow path defined in the device is restricted to the container unit, e.g. by the container gas duct.
55. The device of any one of the preceding aspects,
   wherein the device comprises a gas flow path adjuster.
56. The device of aspect 55,
   wherein the gas flow path adjuster is arranged to define and/or to focus the gas flow path in the intermediate region of the gas flow path between the gas flow generation unit and the container unit.
57. The device of aspect 55 or 56,
   wherein the gas flow path adjuster is configured to change the size and/or shape of the cross section of the gas flow path, e.g. from a first size and/or shape at a first end of the gas flow path adjuster closer to the gas flow generation unit as seen along the gas flow path to a second size and/or shape at a second end of the gas flow path adjuster further away from the gas flow generation unit.
58. The device of any one of aspects 55 to 57,
   wherein the gas flow path adjuster is configured to adjust the cross section of the gas flow path, e.g. in size and/or shape, to the cross section of the container carrier or the outer boundary of the container region of the gas flow path.
59. The device of any one of aspects 55 to 58,
   wherein the gas flow path adjuster has a first end facing towards the gas flow generation unit as seen along the gas flow path, the first end having a cross section which is greater than the cross section of a second end of the gas flow path adjuster remote from the gas flow generation unit or facing the container unit.
60. The device of any one of aspects 55 to 59,
   wherein the gas flow path adjuster has a continuous opening at the first end and/or a continuous opening at the second end.
61. The device of any one of aspects 55 to 61,
   wherein the first end of the gas flow path adjuster is configured to receive the gas flow, e.g. the entire gas flow, originating at the gas flow generation unit and the second end is configured to supply the gas flow towards the container unit.
62. The device of any one of the preceding aspects,
   wherein the device comprises a gas flow divider, wherein the gas flow divider is arranged between the gas flow generation unit and the container region as seen along the gas flow path.
63. The device of aspect 62,
   wherein the container unit comprises the gas flow divider, e.g. fixed to the container unit base.
64. The device of aspect 62 or 63,
   wherein the gas flow divider is arranged between the gas flow path adjuster and the container region as seen along the gas flow path.
65. The device of any one of aspects 62 to 64,
   wherein the gas flow divider is configured to direct incoming gas flow into the sections of the gas flow path in the container region.
66. The device of aspect 65,
   wherein the sections are adjusted to the positions of the container receptacles relative to the gas flow divider, preferably such that each container has at least one section of the gas flow path extending over opposite surfaces, e.g. main surfaces, of the containers.
67. The device of any one of aspects 62 to 66,
   wherein the gas flow divider is configured to define a plurality of sections of the gas flow path.
68. The device of any one of the preceding aspects,
   wherein the number of sections equals the number of container receptacles arranged in one column plus one.
69. The device of any one of aspects 62 to 68,
   wherein the gas flow divider comprises one or a plurality of gas deflectors to define the sections of the gas flow path in the container region and/or to direct the gas flow into the sections.
70. The device of aspect 69,
   wherein the number of gas deflectors equals the number of container receptacles arranged in stacked fashion above one another, e.g. in one column of container receptacles.
71. The device of aspect 69 or 70,
   wherein a height of the respective gas deflector at an end of the gas flow divider remote from the gas flow generation unit as seen along the gas flow path is adjusted to the height of the containers and/or to the height of the container receptacles.
72. The device of any one of aspects 69 to 71,
   wherein, as seen along the gas flow path, the gas deflectors widen from the gas flow generation unit towards the container region.
73. The device of any one of aspects 69 to 72,
   wherein the respective gas deflector is oriented along, e.g. parallel to, a width direction of the container receptacles and/or along the movement axis of the container unit.
74. The device of any one of aspects 69 to 73,
   wherein the gas deflectors are oriented in parallel to one another.
75. The device of any one of aspects 69 to 74,
   wherein the gas deflectors have a triangular cross section, e.g. when the section is taken along the gas flow direction of the gas flow path from the gas flow generation unit to the container region.
76. The device of any one of aspects 55 to 75,
   wherein a distance between an end of the gas flow divider facing the gas flow path adjuster and an end of the gas flow path adjuster facing the gas flow divider as seen along the gas flow path is less than or equal to one of the following values: 50 cm, 40 cm, 30 cm, 25 cm, 20 cm, 15 cm, 10 cm, 5 cm, 4 cm, 3 cm, 2 cm, 1 cm.
77. The device of any one of the preceding aspects,
   wherein the gas flow path is limited laterally by, e.g. circumferentially sealed by, a flexible member, e.g. a foil, in a region of the gas flow path between the gas flow generation unit and the container unit.
78. The device of aspect 77,
   wherein the region connects, e.g. directly connects, the gas flow path adjuster to the gas flow divider, wherein, preferably, the flexible member is fixed to the gas flow path adjuster and to the gas flow divider.
79. The device of aspect 77 or 78,
   wherein the flexible member allows movement of the gas flow divider relative to the gas flow path adjuster.
80. The device of any one of aspects 55 to 79,
   wherein the gas flow divider is movable relative to the gas flow path adjuster, e.g. in a direction perpendicular to the main extension of the containers, in the width direction of the container receptacles and/or perpendicular to the extension of the sections of the gas flow path in the container region.
81. The device of aspect 80,
   wherein the gas flow divider is movable along the end of the gas flow path adjuster facing the gas flow divider as seen along the gas flow path.
82. The device of any one of aspects 80 and 81,
   wherein the gas flow divider and, preferably, the amplitude of the movement of the gas flow divider relative to the gas flow path adjuster are adjusted to the gas flow path adjuster such that in any relative position of the gas flow divider relative to the gas flow path adjuster a gas inlet of the gas flow divider covers, preferably completely covers, the gas outlet of the gas flow path adjuster.
83. The device of aspect 82,
   wherein a gas inlet of the gas flow divider is dimensioned to be greater than a gas outlet of the gas flow path adjuster, e.g. in the movement direction of the gas flow divider such as only in the movement direction.
84. The device of any one of the preceding aspects,
   wherein the device comprises a trigger mechanism, e.g. a switch, to initiate an operation cycle.
85. The device of any one of the preceding aspects,
   wherein the device comprises a timer, which, after a predetermined time has elapsed, ends the operation cycle, e.g. by switching the device off.
86. The device of any one of the preceding aspects,
   wherein the device is configured such that the gas flow generation unit and/or the motor moving the container unit operate during the entire operation cycle of the device, e.g. with preset parameters, the parameters being preferably constant during the entire operation cycle, wherein the parameters may comprise the frequency of the movement of the container unit, the time for which the gas flow generation unit is operated and/or the time for which the container unit is moved, wherein the container movement time and the gas flow generation unit operation time may be equal (then one timer may be sufficient) or different (then two timers may be required).
87. The device of any one of the preceding aspects,
   wherein the device is configured such that the device is capable of thawing the content of 15 containers with a fill volume of more than 10 L and/or less than 20 L (L: Liter) within a predetermined time.
88. The device of aspect 87,
   wherein the predetermined time is less than or equal to one of the following values: 20 h, 19 h, 18 h, 17 h, 16 h, 15 h, 14 h, 13 h, 12 h, 11 h, 10 h, 9 h, 8 h, 7 h, 6 h.
89. The device of aspect 87 or 88,
   wherein the predetermined time is greater than or equal to one of the following values: 4 h, 5 h, 6 h, 7 h, 8 h, 9 h, 10 h.
90. The device of any one of the preceding aspects,
   wherein the container receptacles are configured alike.
91. The device of any one of the preceding aspects,
   wherein a height of the respective container receptacle, e.g. the dimension perpendicular to the movement axis of the container carrier and/or perpendicular to the direction of the gas flow path in the container region, is less than a width of the respective container receptacle, e.g. the dimension along the movement axis of the container carrier and/or perpendicular to the direction of the gas flow path in the container region, and/or less than a length of the respective container receptacle, e.g. the dimension perpendicular to the movement axis of the container carrier and/or the direction along the gas flow path in the container region.
92. The device of any one of the preceding aspects,
   wherein the device is a thawing device, preferably a dedicated thawing device, e.g. not configured for freezing and/or only designed for thawing.
93. The device of any one of the preceding aspects,
   wherein the device is free of any one of, any arbitrarily selected plurality of, or all of:
      an active heating unit to influence the temperature of the containers in the receptacles,
      an active cooling unit to influence the temperature of the containers in the receptacles,
      a temperature monitoring unit to monitor the temperature of the containers.
94. The device of any one of the preceding aspects,
   wherein the gas moved along the gas flow path by the gas flow generation unit during operation of the device is air, e.g. ambient air.
95. The device of any one of the preceding aspects,
   wherein the container receptacles are configured to hold containers with a fill volume of greater than or equal to one of the following values: 6 L, 7 L, 8 L, 9 L, 10 L, 11 L, 12 L.
96. The device of any one of the preceding aspects,
   wherein the container receptacles are configured to hold containers with a fill volume of less than or equal to one of the following values: 20 L, 19 L, 18 L, 16 L, 15 L, 14 L, 13 L, 12 L.
97. The device of any one of the preceding aspects,
   wherein the device is configured to thaw the frozen equivalent of 160 L of liquid content, e.g. distributed over 15 bags, in less than 13 h, e.g. in less than 12 h or in less than 11 h or in less than 10 h or in less than 9 h, from −50° C. to 15° C. or from −60° C. to 15° C. using ambient air in an air-conditioned room with a set ambient temperature between 18 and 25° C. and a room height of 3 meters, e.g. at least three meters, and a floor space of 3×5 m², e.g. of at least 3×5 m₂.
98. The device of any one of the preceding aspects,
   wherein the device is configured such that the gas flow velocity in the sections between the containers, when the containers are arranged in the container receptacles, is greater than or equal to one of the following values: 1.5 m/s, 1.6 m/s, 1.7 m/s, 1.8 m/s, 1.9 m/s, 2 m/s, 2.5 m/s, 3 m/s, 3.5 m/s, 4 m/s, 4.5 m/s, 5 m/s, 5.5 m/s, 6 m/s, 7 m/s, 8 m/s, 9 m/s, 10 m/s, 10.5 m/s, 11 m/s, 11.5 m/s, 12 m/s.
99. The device of any one of the preceding aspects,
   wherein the content, e.g. the frozen content, of the respective container is a medical liquid, e.g. a pharmaceutical liquid, such as a liquid comprising an active pharmaceutical ingredient, e.g. an ingredient of a vaccine, such as a Corona virus vaccine.
100. The device of any one of the preceding aspects,
   wherein the containers comprise flexible bags.
101. The device of any one of the preceding aspects,
   wherein, in the sections of the gas flow path in the container region, the gas flow direction is perpendicular to gravity and/or along a support surface supporting the chassis of the device.
102. The device of any one of the preceding aspects,
   wherein the device comprises one or more locking members configured to lock the containers in the container receptacles against movement relative to the container carrier.
103. The device of aspect 102,
   wherein one locking member is configured to lock containers in different container receptacles, e.g. in different container receptacles of one column or in different receptacles of two columns.
104. The device of aspect 102 or 103,
   wherein the respective locking member is releasably connectable to the container carrier.
105. The device of any one of the preceding aspects,
   wherein the container receptacles are accessible in the remote region or outlet region of the gas flow path such that containers can be loaded into the container receptacles from the outlet or the remote region.
106. The device of any one of the preceding aspects,
   wherein the distance of the oscillating movement of the container unit from one extreme position to the other extreme position is greater than or equal to: 2 cm, 2.5 cm, 3 cm, 4 cm (cm: centimeters).
107. The device of any one of the preceding aspects,
   wherein the distance of the movement of the container unit from one extreme position to the other extreme position is less than or equal to: 6 cm, 5 cm, 4.5 cm, 4 cm.
108. The device of any one of the preceding aspects,
   wherein the amplitude of the oscillating movement of the container unit away from a neutral or central position, e.g. relative to the gas flow path adjuster, towards either one of the two extreme positions is greater than or equal to one of the following values: 1 cm, 2 cm.
109. The device of any one of the preceding aspects,
   wherein the amplitude of the oscillating movement of the container unit away from a neutral or central position, e.g. relative to the gas flow path adjuster, towards either one of the two extreme positions is less than or equal to one of the following values: 3 cm, 2 cm.
110. The device of any one of the preceding aspects,
   wherein the container receptacles and/or the containers are configured such that the distance between two adjacent containers (e.g. vertically and/or horizontally adjacent containers) and/or the width of the sections of the gas flow path in the container region (e.g. the vertical height of the sections), when the containers are arranged in adjacent receptacles is greater than or equal to 1 cm and/or less than or equal to 5 cm.
111. The device of any one of the preceding aspects, wherein
   a frequency of the movement of the container unit is fixed or can be varied, e.g. such that a frequency is chosen, with the chosen frequency being constant until the container unit movement is stopped.
112. A system comprising:
   the device of any one of the preceding aspects and
      a) one or more containers with liquid, e.g. liquid for a thawing operation, and/or
      b) one or more dummy containers which are sized and shaped to be inserted into the container receptacles, e.g. if the number of containers to be processed by the device in one operation cycle is less than the number of container receptacles available in the device.
113. A method for simultaneously thawing the frozen contents of a plurality of containers using the device or a system of any one of the preceding aspects comprising the following steps:
   arranging the containers with frozen content within the container receptacles,
   optionally arranging dummy containers in any empty container receptacle,
   initiating gas flow generation via the gas flow generation unit for conducting an operation cycle,
   optionally moving the container unit relative to the gas flow generation unit during the operation cycle,
   maintaining the gas flow and, if applicable, the container unit movement for a predetermined time.

Further features, advantages and expediencies will become apparent from the following description, inter alia, of the accompanying drawings.

### BRIEF DESCRIPTION OF THE DRAWINGS

FIGS. 1A and 1B illustrate an exemplary embodiment of the device on the basis of perspective views from different sides.

FIG. 2 illustrates a gas flow path adjuster and a container unit of the embodiment of FIGS. 1A and 1B.

FIG. 3 illustrates a control panel of the device.

FIG. 4 illustrates a flexible member and its position within the device.

FIG. 5 illustrates properties of frozen biopharmaceutical liquids thawed using the device with different frequencies of a container movement.

FIGS. 6A to 6D illustrate thawing processes for different scenarios.

FIGS. 7A and 7B illustrate another embodiment of the thawing device.

### DESCRIPTION OF THE EXEMPLARY EMBODIMENTS

In the figures, identical elements, identically acting elements and elements of the same kind may be provided with the same reference signs.

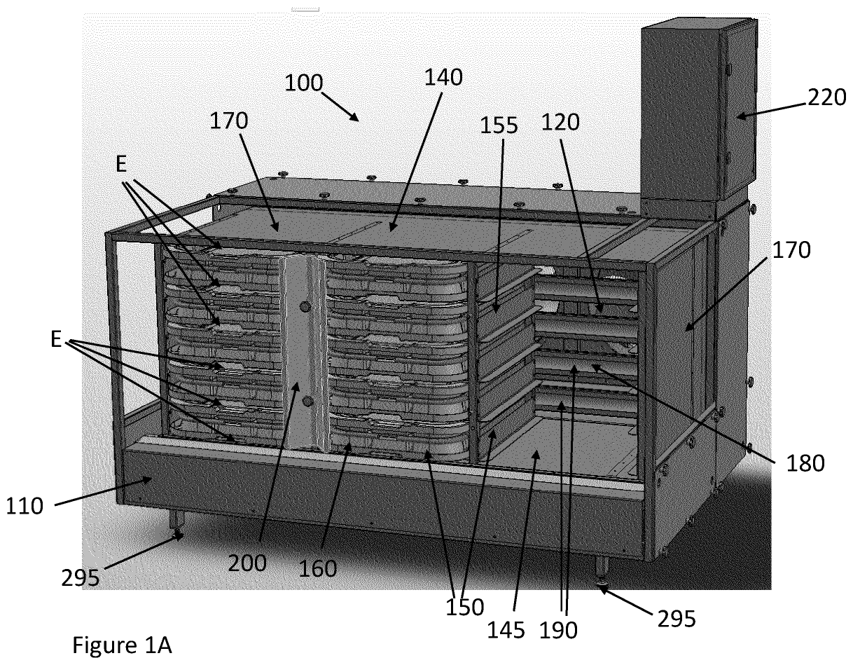

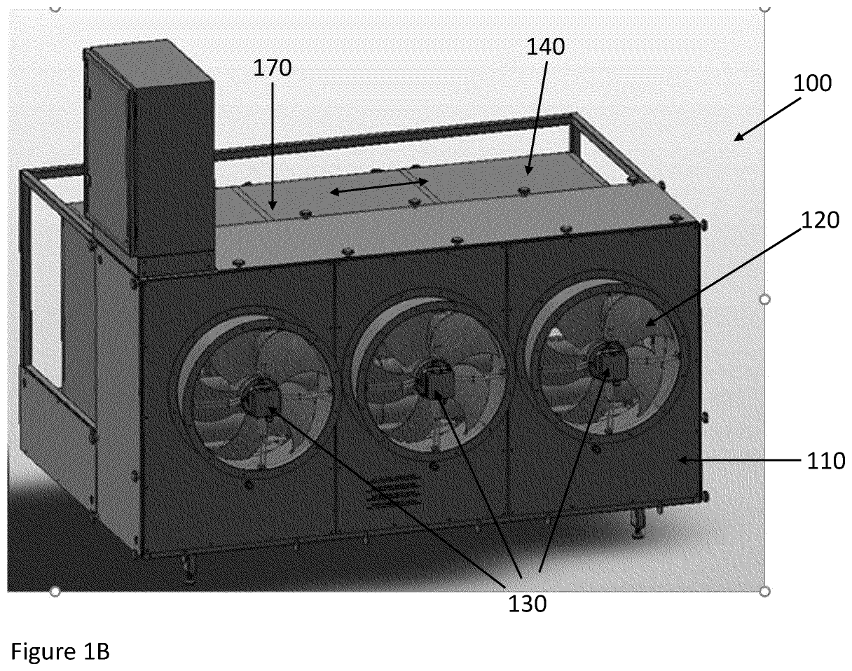

FIGS. 1A and 1B illustrate one embodiment of the device for accelerating thawing of the content of containers in perspective view.

The device 100 (also designated as thawing device) comprises a chassis 110. A gas flow generation unit 120 is mounted to the chassis 110. The gas flow generation unit 120 depicted in FIGS. 1A and 1B comprises a plurality of fans 130 (or gas flow generation members). The device 100 further comprises a container unit 140. The container unit 140 is movable relative to the chassis 110 and/or the gas flow generation unit 120. The movement of the container unit may be linear movement, expediently restricted to movement along one axis, e.g. in opposite directions. The gas flow generation unit 120 is configured to displace air towards the container unit 140. The fans 130 can move the air from the room in which the device 100 is set up towards the container unit 140 in a blowing operation. Thus, the air flow may be formed by ambient air from any room the device is positioned in without having to fulfil particular requirements as regards cleanliness. In other words, the device does not have to be set up in a cleanroom. The room, preferably, is air-conditioned, e.g. to a temperature of 18 to 25° C. The air flow direction from the gas flow generation unit 120 to the container unit 140 may be perpendicular with respect to the movement axis for the movement of the container unit 140 relative to the gas flow generation unit 120 or the air flow direction through the container unit.

The container unit 140 comprises a container carrier 155. The container carrier 155 comprises one or more container receptacles 150 in the container carrier 155. Each container receptacle 150 is suitable to receive one container 160 with a frozen liquid, e.g. only one container can be received per receptacle.

The container receptacles 150 (exemplarily 15 in the illustrated embodiment) are distributed over a variety of racks arranged beside each other (three racks in the embodiment with five receptacles per rack), e.g. along the movement direction of the container unit 140 relative to the chassis 110 or the gas flow generation unit 120.

In the depicted embodiment, three racks are provided, where the two racks on the left are completely filled with stacked containers 160, e.g. Sartorius Celsius® FFT bags or other bags suitable for handling and storing liquids, especially biopharmaceutical liquids. The liquid in the containers may comprise RNA and/or liposomes. The liquid may be a vaccine, e.g. a corona vaccine. The liquid may be a bulk drug product for Comirnaty.

The rack on the right is empty for illustration purposes in FIG. 1A. The container receptacles 150 are configured to receive containers 160 that have an identical structure and/or form. If the content of less than 15 containers 160 is to be thawed, the empty receptacles within the container unit 140 are expediently blocked or provided with dummy units (e.g. empty Sartorius Celsius® FFT bags or dedicated dummy units) to ensure a uniform distribution of the air flow within the container unit 140. Adjustments for handling different containers can be made, e.g. by adaptors or retrofits. In the illustrated embodiment, the container unit 140 is illustrated as designed to fit up to 15 containers 160 containing frozen liquid (Sartorius Celsius® FFT bags in the depicted example). Exemplarily the containers may be 12 L bags, with a safe core housing. The safe core housing may provide structural rigidity to the bag during the thawing. The number and/or fill volume of the bags can vary. As noted, if a smaller number than the one for which the device is designed should be thawed (in the present embodiment up to 15 containers can be thawed simultaneously), dummy spacers can inserted into the empty racks to ensure a uniform air flow through the container unit 140, the flow being driven by the gas flow generation unit.

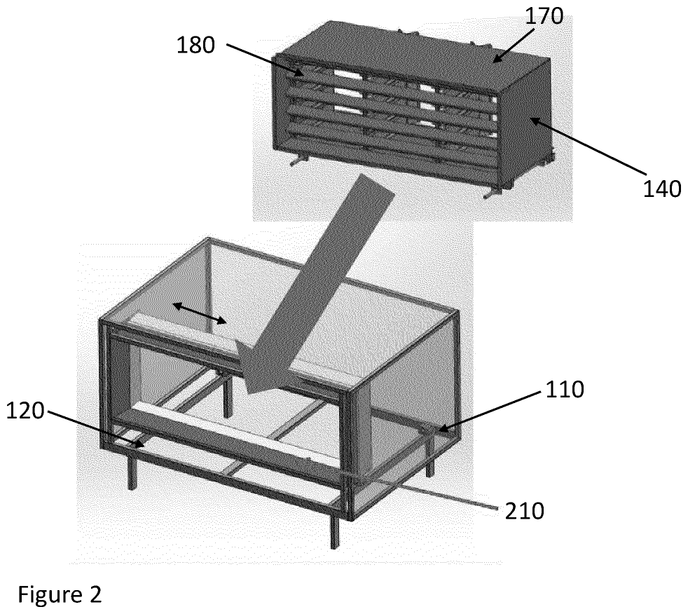

The containers or bags 160 (references to bags herein are understood as reference to containers), may be loaded into the container unit 140 from the front, and are supported by the container carrier 155 or rack system. Expediently, the container carrier 155 is configured so as to permit (maximum) uninhibited air flow around the surface of the bag. This may enhance the thawing process. The bags are loaded into the racks at a height of 0.5 to 1.1 m above the floor. The height may be adjusted by height-adjustable feet 295 of the chassis 110. The bags 160 expediently are bioprocessing bags, and may be distributed over only 5 shelves, if a limited height is desired for the device, as exemplarily illustrated in connection with FIG. 2, showing a container unit 140 having (only) 5 shelves (expediently per rack).

As shown in FIGS. 1A and 1B, the container carrier 155 comprises a plurality of receptacles 150 arranged above each other. Alternatively, the geometry of the containers or bags and the positioning of the bags relative to the air flow may differ from what is illustrated in FIGS. 1A and 1B, e.g. the bags can be disposed either horizontally and/or vertically and/or frontally relative to the air flow in the receptacles or the container unit. The bags are also disposable such that they are arranged beside each other. The bags (with expediently frozen content) in the depicted embodiment are stacked with a distance in between, the spacing between the bags or the containers varying between about 1 cm to about 5 cm (where “about” covers a deviation of +/−5%). The distance may define the channels for the air flow between the bags during thawing, especially their width, such as their vertical width.

The proposed device 100 exhibits a geometry in which the container carrier 155 comprises a plurality of rows of container receptacles 150 and/or a plurality of columns of container receptacles 150, each row of container receptacles and/or each column of container receptacles comprising a plurality of containers 160. The columns may be part of separate racks which may be rigidly connected to one another or formed in a single integrated rack structure. Once the containers 160 are loaded into the receptacles, they can be held in place by locking members or plates 200, e.g. attached using wing nuts (not illustrated in the figure) to the container carrier 155. One common locking member 200 may be used for two columns. Air flow is directed over the surfaces of the mounted or loaded containers 160 (e.g. using ducts such as stainless steel ducts) to ensure efficient, consistent and/or homogeneous airflow across all the containers 160 within the container carrier 155. The number of containers or bags 160 in the columns and/or rows of the container carrier is greater than or equal to: 2, 3, 4, 5, while the number of containers in the columns and/or rows is less than or equal to: 10, 9, 8, 7, 6, 5. The number of containers 160 in one row is greater than or equal to 2 and less than or equal to 5, e.g. 3. The number of container receptacles in one column is greater than or equal to 2 and less than or equal to 8, e.g. 5.

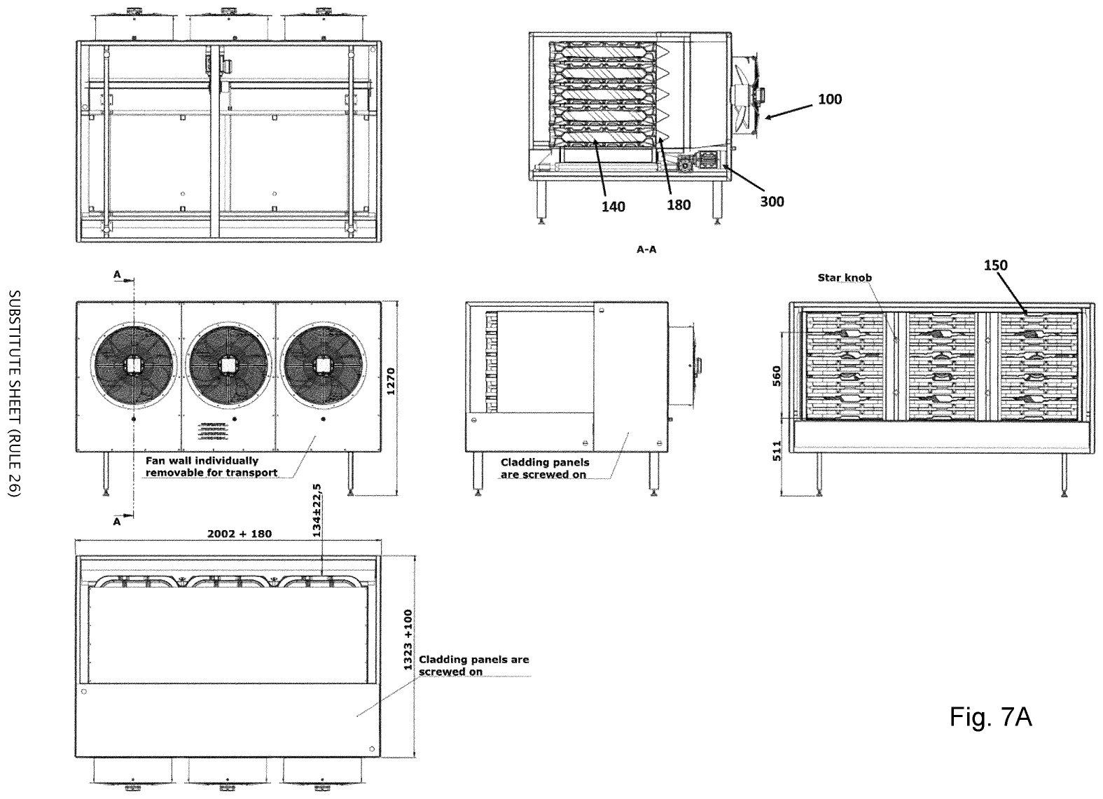

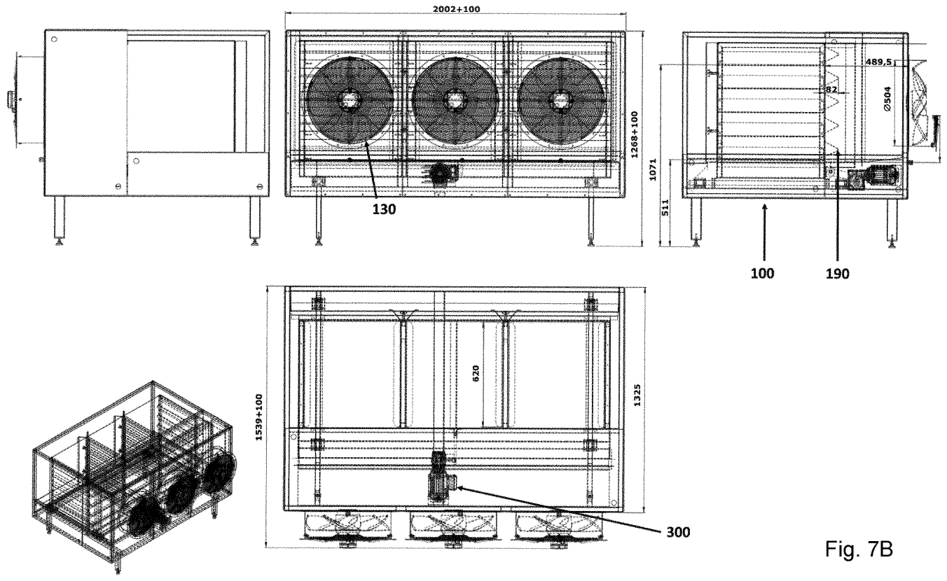

The plurality of containers 160 can be loaded into the racks of the container carrier 155, e.g. from the front (i.e. that side which is shown in FIG. 1A). The containers 160 in the respective rack are stacked above one another in a column, e.g. in one column per rack. The container carrier 155 comprises a plurality of racks arranged beside each other (three racks in the depicted example). The rack(s) may be a mobile rack or a swinging rack. The swinging rack (or moving container carrier 155) may be driven by a geared motor (not explicitly shown in FIGS. 1A and 1B, see reference numeral “300” in FIGS. 7A and 7B) on a horizontal axis, e.g. only along the axis. This moves the containers relative to the airflow which is beneficial for thawing purposes as the convection along the container surfaces can be enhanced and/or the air flow at the containers can be disturbed. The air flow along the containers may be non-laminar or, in the alternative, laminar.

In the illustrated embodiment of FIG. 1, each rack can receive five containers 160, i.e. each rack has five container receptacles 155. Other numbers of containers or racks or receptacles are possible of course. The receptacles of one rack are arranged in a column-like or stacked arrangement.

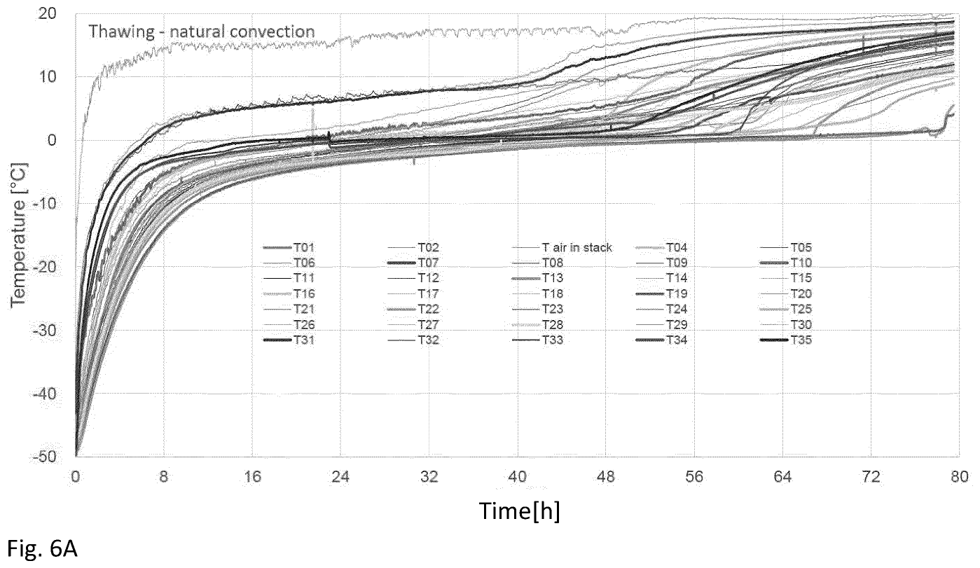

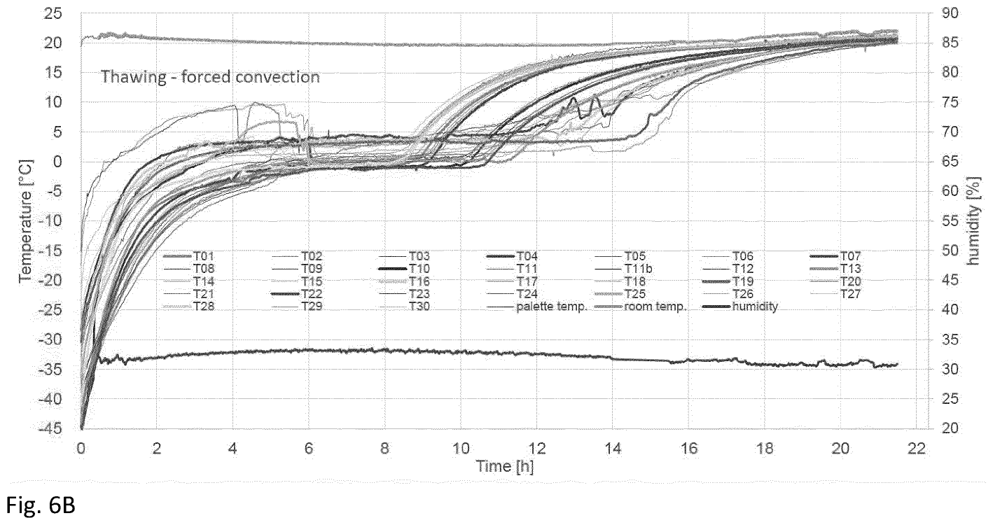

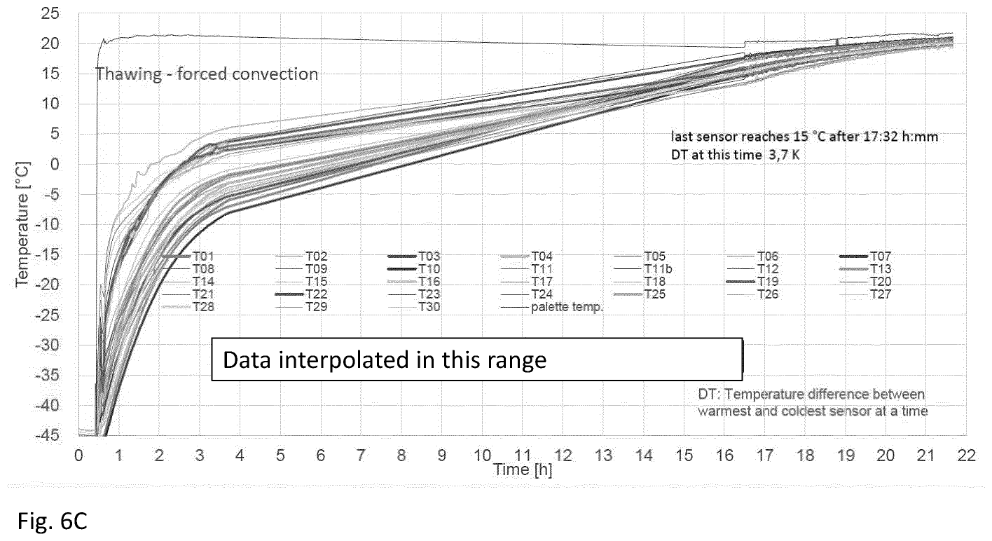

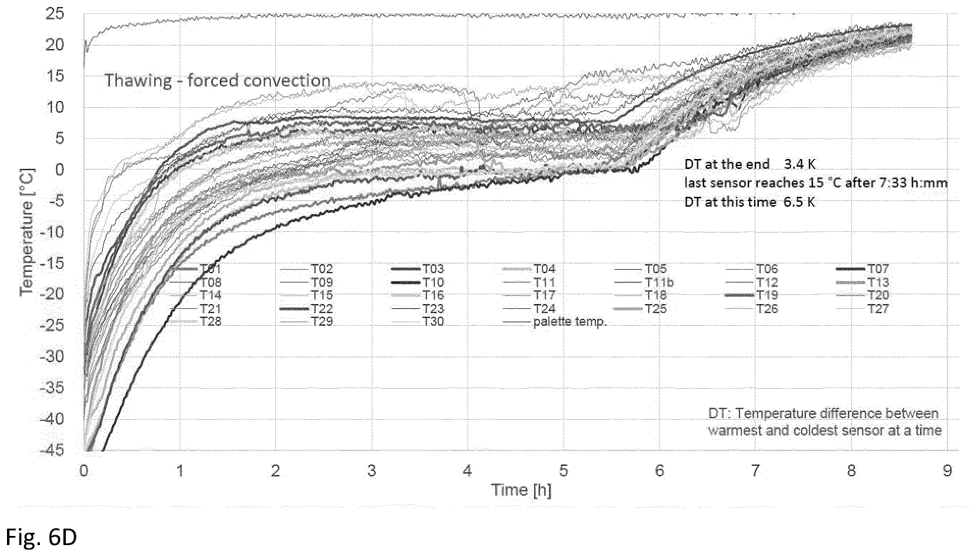

The illustrated embodiment of FIGS. 1A and 1B is shown as receiving as container 160 a Sartorius® type bag (e.g. Sartorius Celsius® FFT bags). The container unit 140 is not limited to receiving only this type of bags, and other type of bags are also possible to be used. A retrofit of the container carrier may be required or may be provided to facilitate the adjustment to different bags. The bags may be or may comprise Sartorius® Celsius FFT 12 L Thermowell Bioprocessing bags, that, as opposed to the standard Celsius FFT bag, permit sensors, e.g. temperature sensors, to be placed at locations inside the bag or have sensors placed at locations (which is advantageous if the thawing progress should be monitored electronically or for evaluation purposes of evaluating different thawing scenarios, see FIGS. 6A to 6D). The sensors may be placed directly into thermowell cavities of the Thermowell Bioprocessing bags, or may be placed between the inner plastic bag and the outer shell of the standard Celsius FFT bags. Alternatively or additionally, the bag may be a composite of two exterior shells and two plates placed on each side of a bag core, this arrangement (the so called safe core system) capable of immobilizing the bag load, either when liquid or frozen. Sartorius® Celsius FFT bags may feature such a safe core system.

As mentioned, the proposed device further comprises, in addition to the container unit 140, the gas flow generation unit 120. As will be discussed in detail in the following, the gas flow generation unit 120 is operable to generate a gas flow (also termed air flow further above as, in the described embodiment, the gas is expediently air but different gas could be used as well) along a gas flow path defined in the device 100. The device 100, in the region of the container carrier 155, is configured to define a container region of the gas flow path. In the container region of the gas flow path, a section of the gas flow path extends along the exterior of the container 160, when the container 160 is arranged in the container receptacle 150, and preferably, the device 100 is configured such to enhance the gas flow or force convection at the exterior of the container 160.

A container gas duct 170 of the container unit 140 surrounds the container carrier 155 to define a lateral boundary of the gas flow path through the container unit 140. The gas duct 170 may also delimit the container region circumferentially, e.g. relative to the gas flow direction. Through the gas flow path, air (or more generally gas) originating from the gas flow generation unit 120 can travel during the operation of the device, particularly in different sections, in order to enhance or force the convection of air at the exterior surfaces of the containers 160. In the container region, an exterior surface of a container, in cooperation with the inner wall of the container gas duct 170, delimits a section of the gas flow path (this container may be the one closest to the inner surface of the container gas duct). The container gas duct 170 is fixed with respect to the container carrier 155. Preferably, the container gas duct 170 and the container carrier 155 are fixed to a common base of the container unit 140. The container receptacles 150 and/or the container carrier 155 are laterally surrounded by the container gas duct 170. In the region of the container unit 140, the gas flow path defined in the device 100 is restricted to the container unit 140 by the container gas duct 170, as shown in FIG. 1A.

The container receptacles, particularly with respect to their height, e.g. upwards in FIG. 1A, are adjusted such that, if they are filled with containers, between two adjacent containers in one rack, which are arranged above one another, and/or between an inner wall of the container gas duct 170 and the container 160 adjacent to that inner wall, gas flow path sections or channels are formed through which the air can flow-driven by the gas flow generation unit 120. The air may leave the device in the regions between two adjacent containers and/or between the container gas duct 170 and the adjacent container 160. The width of the gas flow path sections may be defined by the gap between adjacent containers or the gap between the container and the inner wall of the gas duct 170. The (vertical) width of the gas flow path sections (e.g. maximum, minimum, and/or average width) in the container region or the container unit may be greater than or equal to 0.5 cm and/or less than or equal to 10 cm, e.g. between 1 cm and 5 cm. Here the width may be defined by the vertical distance between two adjacent containers. The racks or the columns of receptacles of the container unit 155 may be fluidically separated from each other, for example by a separating wall between adjacent racks or columns. The regions where the air can exit the device are highlighted with “E” in the leftmost rack in FIG. 1A. In the other racks, these regions are positioned accordingly.

The container receptacles 150 may be adjusted such that one or more supporting surfaces of the respective receptacle 150, e.g. provided by inwardly protruding rail-like structures (see the rightmost rack), cover only a small proportion of the surface of the container for supporting or bearing purposes to maintain the container 160 in position. The remainder of the surface of the container is available for exposure to the air flow and, hence, for heat transfer from the air to the container. In this way, thawing may be accelerated by means of effective heat transfer in the container region of the gas flow path through the device 100 (i.e. that region of the gas flow path extending through the container carrier 155).

In the device 100, a main gas flow direction in the sections of the gas flow path in the container region is oriented along a main extension direction of the containers 160 when the containers 160 are received in their respective container receptacles 150. The main extension direction is a longitudinal direction or length direction, such as a direction along which the containers have their maximum extension or maximum length. In the container region, each container 160 is directly exposed to the gas flow along at least one section of the gas flow path. Preferably each container 160 is directly exposed to the gas flow along a plurality of sections of the gas flow path, the container expediently being arranged between the two sections. This may also enhance the heat transfer from the gas to the container.

Each of the gas flow generation members 130 or fans is operable to generate a gas flow which contributes to the total gas flow along the gas flow path. The gas flow generation members are linearly arranged, preferably in a one-dimensional arrangement in one row. In the device 100, the different gas flow generation members are assigned to different columns of container receptacles 150. Alternatively or additionally, the gas flow generation members are arranged to generate gas flow in parallel directions. FIG. 1B illustrates a particular implementation of the gas flow generation members according to which the respective gas flow generation member is a fan 130, but the gas flow generation member is not limited to this embodiment. As evident from the figure, the fans 130 or gas flow generation members are arranged such that their rotation axes are parallel.

The (respective) gas flow generation member 130 is configured to provide a gas displacement of greater than or equal to one of 3000 m³/h, 4000 m³/h, 4500 m³/h, 4900 m³/h, 5000 m³/h (m: meter, h: hour). Further, the (respective) gas flow generation member is configured to provide a gas displacement of less than or equal to one of 7000 m³/h, 6500 m³/h, 6000 m³/h, 5500 m³/h 5000 m³/h. The gas flow generation unit is configured to generate a gas flow with a gas flow velocity (measured at the unit, e.g. at the outlet of the fan(s)) of greater than or equal to one of 1.0 m/s, 1.1 m/s, 1.2 m/s, 1.3 m/s, 1.4 m/s, 1.5 m/s, 1.6 m/s, 1.7 m/s, 1.8 m/s, 1.9 m/s, 2 m/s, 2.5 m/s, 3 m/s, 3.5 m/s, 4 m/s, 4.5 m/s, 5 m/s (m: meter, s: second). The gas flow generation unit 120 is configured to generate a gas flow with gas flow velocity of less than or equal to one of 8 m/s, 7 m/s, 6.5 m/s, 6 m/s, 5.5 m/s, 5 m/s, 4 m/s, 3.5 m/s, 3 m/s, 2.5 m/s, 2 m/s, 1.5 m/s. The gas flow may be between 1 m/s and 5 m/s. The gas flow generation unit is configured to provide a total gas displacement (provided by all of the gas flow generation members) of greater than or equal to one of 9000 m³/h, 10000 m³/h, 11000 m³/h, 12000 m³/h, 13000, 14000 m³/h, 14500 m³/h, 15000 m³/h. The gas flow generation unit is configured to provide a total gas displacement of less than or equal to one of 21000 m³/h, 19500 m³/h, 18000 m³/h, 16500 m³/h, 15000 m³/h. The total gas displacement may be between 9000 m³/h and 21000 m³/h, e.g. 15000 m³/h.

The gas flow generation unit 120, illustrated in FIG. 1B, in accordance with an embodiment of the present disclosure, comprises a plurality of, e.g. three, fans or gas flow generation members 130 mounted horizontally adjacent to each other, such as in a row. The gas flow generation unit 120 is configured to e.g. produce a total air displacement of 15 000 m³/h and/or at a velocity of 5 m/s (at the respective fan or the gas flow generation unit). An exemplary specification for each of the represented fans 130 might be: Manufacturer: Rosenberg; Product key: AKFE500-4G(S). 5HAA7; Voltage (V): 160˜, 50 Hz; Rotational speed (min⁻¹) 1150; Static pressure rise (Pa): 75; Volume flow rate (m³ h⁻¹) 4980; Current consumption (A): 2.7; Electrical power consumption (kW): 0.4; Sound power level at inlet (dB(A)): 66; Sound power level at outlet (dB(A)): 67. The respective fan may be driven by an electromotor.

We note that the positioning or mode of operation of the fans relative to the bags is such that the air is pushed from the fans to the bags rather than drawn over the bags. This will permit the contribution of the thermal losses of the fan motors to the thawing process, thus potentially reducing the total thaw time. There is a potential reduction in air flow uniformity across the racks and bag length, but this lack of uniformity may be compensated by the mechanical mixing of the fluid provided by the movement of the container carrier.

The gas flow path comprises an intermediate region, which is arranged between the container region and the gas flow generation unit 130 as seen along the gas flow path, and/or a remote region which, as seen along the gas flow path, is arranged on that side of the container region remote from the gas flow generation unit (e.g. on the side of the air exit regions E). The gas flow generation unit 120 is configured to displace gas towards the container region via the intermediate region, such that the gas flow direction in the gas flows from the gas flow generation unit via the intermediate region to the container region and/or from the container region to the remote region where the gas may exit the device. The gas flow generation unit is configured to displace the gas along the gas flow path towards the container region in a blowing mode of operation of the gas flow generation unit as has been discussed above. As noted, this offers the option of increasing the temperature at the containers due to the loss heat of the gas flow generation members.

It has been found that the warming rates at the edge and in the core of the bags/containers (e.g. Sartorius® Celsius FFT bags) are dependent on the geometry and configuration of the bags. This difference can be reduced by increasing the air flow rate, thus reducing the effect of geometry and/or ambient temperature. No advantage was observed by keeping the air flow in the laminar range. Thus, non-laminar flow can be used. High air flow rates (e.g. >1.5 m/s) can be used to normalize thawing rates across bags, e.g. across bags of non-equal fills.

In the device 100, for two adjacent container receptacles 150, and preferably any two vertically and/or laterally adjacent container receptacles 150, one section of the gas flow path in the container region of the gas flow path is formed between the containers 160, when the containers 160 are arranged in these two adjacent receptacles. Preferably each container 160, when in the container receptacle 150, is sandwiched between two sections of the gas flow path. As mentioned above, the device 100 comprises the chassis 110. The gas flow generation unit 120 is mounted to the chassis 110. The container carrier 155 is movably connected to or is connectable to the chassis 110, e.g. via one or more guide rails.

The chassis 110 of the device 100 has adjustable feet 295, that may have a variable length, to ensure the provision of a level axis of motion for a shaking bed or moving container carrier, that is also integrated in device 100. The air flow can be channeled over the bags 160 and/or within the device by enclosing the chassis 110 in stainless steel paneling (forming a gas duct for the chassis). The range of freedom of the shaking or rocking bed (i.e. of the container unit) is expediently independent from this gas duct or stainless steel paneling.

As will be discussed further in more detail in the following sections, the container unit 140 is movable relative to the chassis 110 and/or the gas flow generation unit 120. The container unit 140 is movably connected to the chassis 110. The container unit 140 is movable relative to the chassis 110 and/or relative to the gas flow generation unit 120 in at least one direction, such as linearly, e.g. only linearly. The container unit 140 can be connected to the chassis 110 such that movement of the container unit 140 relative to the chassis 110 is restricted to linear movement along a movement axis. This may be achieved by guide rails or guide slots or the like on the chassis 110 which interact with features of the container unit 140, e.g. on the container carrier 155, to restrict or guide the movement. The movement axis is fixed in position relative to the chassis 110 and/or relative to the gas flow generation unit 120. The container unit 140 is movable along the movement axis in opposite directions. The movement axis of the linear movement of the container unit 140 is perpendicular to the gas flow path, or perpendicular to the gas flow direction, in the container region. The movement direction is perpendicular to the main longitudinal direction of extension of the containers and/or parallel to a support for the device 100, e.g. the floor of the room, in which the device has been set up. The movement of the container unit 140 relative to the chassis 110 is expediently effected by a motor, comprised as well by device 100 (not explicitly shown in FIGS. 1A and 1B, see FIGS. 7A and 7B, item “300”). The motor is configured to, during operation of the device 100, move the container unit 140 relative to the chassis 110, expediently in different or opposite directions. The motor is mounted to the chassis 110 and is operatively connected to the container unit 140, for example via a gear interface. As it is shown at least in connection with FIG. 1B and indicated by the doubled headed arrow, the device is configured to move the container unit 140 between two extreme positions relative to the chassis 110 and/or the gas flow generation unit 120. For example, the container unit is moved between these extreme positions in an oscillating manner, e.g. during the entire thawing process or operation cycle of the device (or at least for a predetermined time-which may be equal to the duration of the thawing process or less than the duration of the thawing process).

The device 100 is configured such that a frequency of the oscillating movement of the container unit 140 between the two extreme positions is less than or equal to one of: 1.5 Hz, 1.3 Hz, 1.0 Hz, 0.9 Hz, 0.8 Hz, 0.75 Hz, 0.6 Hz, 0.5 Hz (Hz=Hertz). Medical substances, especially biopharmaceutical substances, such as substances comprising RNA, like Comirnaty, are sometimes sensitive to agitations. Excessive agitations during thawing may have negative influences on the thawed liquid, e.g. as to the yield of pharmaceutically active substance which can be retrieved from the thawed liquid, such as by filtering, or as to conducting the filtering of the thawed liquid before a filling process is initiated. The device 100 is further configured such that a frequency of the oscillating movement of the container unit 140 between the two extreme positions is greater than or equal to one of: 0 Hz, 0.01 Hz, 0.1 Hz, 0.2 Hz, 0.3 Hz 0.5 Hz, 0.6 Hz, 0.7 Hz, 0.75 Hz. The amplitude of the oscillations may be fixed, e.g. 4 cm. The device may be configured such that the frequency is variable, e.g. it can be varied by the user, e.g. between 0 Hz and 1.5 Hz (or between 0 Hz and 0.8 Hz) and/or a particular frequency can be selected from a plurality of preset frequencies. The frequency of the movement may be adjustable via a frequency converter, which can be operated by the user to set a desired frequency. The frequency may be between 0.01 Hz and 1.5 Hz. The frequency may be constant during the movement of the container unit 140. The ideal frequency may depend on the particular substance or liquid which needs to be thawed. For Comirnaty, it has been found that a frequency of 0.50 Hz or 0.48 Hz (or below that) and/or greater than 0.01 Hz achieves a particularly high yield and/or is advantageous for the filterability (see further below). 0.32 Hz is a good candidate for the frequency, e.g. for the Comirnaty drug product. However, the yield and/or the filterability with other frequencies was also good. This is discussed further below.

The device 100 also comprises one or more gas inlets and one or more gas outlets. The gas flow path extends from the gas inlets to the gas outlets and/or fluidly connects the gas inlets and the gas outlets. The gas outlet of the device 100 is, or the gas outlets of the device are, in the remote region of the gas flow path (see the regions highlighted with “E” in FIG. 1A). The gas inlet of the device 100 is, or the gas inlets of the device 100 are, defined by the gas flow generation unit 120, e.g. by the rear side of the fans as gas inlets.

The device 100 further comprises a gas flow divider 180. The gas flow divider 180 is arranged in the gas flow path between the gas flow generation unit 120 and the container carrier 155. The gas flow divider 180 comprises a plurality of fins or gas deflectors 190 which are disposed relative to each other such that they define air or gas passages between them, e.g. as longitudinally oriented slits which may extend along the movement axis of the container unit relative to the chassis 110. The air passages are expediently aligned with the regions between the containers 160 and/or between the container 160 and the inner wall of the container gas duct 170. Each region or section may have one and only one aligned air passage which is preferably fluidically separated from the other air passages of the gas flow divider vertically, such as upwards and/or downwards. In this way, air can be reliably guided into the respective section of the gas flow path in the container region such that gas flows along the containers. The gas deflectors 190, e.g. horizontal air ducts, may be placed on the mobile rack (or container carrier 155 or container unit 140) to normalize directional air flow over the bags while the device is in operation or motion. Additional ducting (e.g. the gas flow path adjuster 210 of FIG. 2, see below) may be placed on or connected with the stationary chassis 110 in which the mobile rack or container carrier is placed to direct fan-displaced air into the area of motion of the mobile rack or container carrier.

The container carrier 155, the gas flow divider 180 and/or the container gas duct 170 are expediently connected, e.g. fixedly connected, to a container unit base 145 of the container unit 140. The container unit base 145 may provide or have an interface for the motor (e.g. a toothed portion engageable by a member driven by the motor, e.g. a gear) such that the motor can drive the container unit 140. The base 145 may be arranged at the bottom end of the container unit 140 and/or at that end of the container unit closest to the floor of the room in which the device is situated.

To summarize, the device 100 comprises a gas flow divider 180 arranged between the gas flow generation unit 120 and the container region along the gas flow path. More precisely, it is the container unit 140 that comprises the gas flow divider 180, and exemplarily the gas flow divider 180 is affixed to the base 145 of the container unit 140. The gas flow divider 180 is arranged between the gas flow path adjuster 210 (illustrated in more detail in FIG. 2) and the container region, as seen along the gas flow path. The gas flow divider 180 is configured to direct incoming gas flow into the sections of the gas flow path in the container region. The sections of the gas flow path are adjusted to the positions of the container receptacles relative to the gas flow divider, preferably such that each container has at least one section of the gas flow path extending over the two opposite surfaces of the container (expediently the main surfaces of the container). The gas flow divider 180 is configured to define a plurality of sections of the gas flow path. The number of these sections may equal the number of container receptacles 150 arranged in one column plus one. The gas flow divider 180 also comprises one or a plurality of gas deflectors 190. These deflecting elements define the sections of the gas flow path in the container region and/or direct the gas flow into the sections of the gas flow path in the container region.

FIG. 2 illustrates the container unit 140. FIG. 2 further illustrates a gas flow path adjuster 210 which is fixedly connected to the chassis 110. The gas flow path adjuster 210 is expediently configured to focus the gas flow onto the gas flow divider 180 or the container unit 140 which during operation moves in an oscillating fashion relative to the gas flow path adjuster 210. The position of the container unit 140 relative to the gas flow path adjuster 210 is schematically illustrated by the double-headed arrow which also symbolizes the oscillating movement. The gas flow path adjuster 210 may receive the gas from the gas flow generation unit 120 (not explicitly shown in this representation; arrow 120 hints to the location of that unit) and focus this gas onto the gas flow divider 180. For this purpose, a narrowing region 220 of the gas flow path adjuster 210 may be provided, which reduces the cross-section of the gas flow path, e.g. to a cross-section adjusted to the one of the gas flow divider 180, e.g. at its side facing the outlet of the gas flow path adjuster. The opening of the gas flow path adjuster 210 facing the gas flow divider 180 may be slightly smaller along the movement direction (of the container unit 140) than the extension of the gas flow divider 180 along that direction, e.g. by about 2 cm and/or by the amplitude of the oscillating movement of the container unit 140 or half of the amplitude. In this way, it can be ensured, that the gas flow divider 180 always collects the entire gas flow focused onto it via the gas flow path adjuster 210. The big arrow illustrates where the container unit 140 with the gas flow divider 180 facing the gas flow path adjuster 210 is positioned during the operation of the device 100. The distance between the adjuster 210 and the divider 180 may be less than or equal to one of the following values: 15 cm, 10 cm, 5 cm, 4 cm, 3 cm, 2 cm, 1 cm. The gas flow path adjuster 210 may define a single continuous flow path section.

A distance of the oscillating movement of the container unit 140 from one extreme position to the other extreme position is greater than or equal to: 2 cm, 2.5 cm, 3 cm, 4 cm (cm: centimeters). The distance of the movement of the container unit 140 from one extreme position to the other extreme position is less than: 6 cm, 5 cm, 4.5 cm, 4 cm. The distance between the extreme positions may be between 2 cm and 6 cm, e.g. 4 cm. An amplitude of the oscillating movement of the container unit 140 away from a neutral or central position, defined relative to the gas flow path adjuster 210 or the gas flow generation unit 120, towards either one of the two extreme positions is greater than or equal to one of: 1 cm, 2 cm. The amplitude of the oscillating movement of the container unit 140 away from a neutral or central position, relative to the gas flow path adjuster or the gas flow generation unit, towards either one of the two extreme positions is less than or equal to: 3 cm, 2 cm. The amplitude may be between 1 and 3 cm.

Thus, the device 100 further comprises the gas flow path adjuster 210. The gas flow path adjuster 210 is arranged to define and/or to focus the gas flow path in an intermediate region of the gas flow path between the gas flow generation unit 120 and the container unit 140. The gas flow path adjuster 210 is configured to change the size and/or shape of the cross section of the gas flow path, for example from a first size and/or shape at a first end of the gas flow path adjuster, closer to the gas flow generation unit as seen along the gas flow path, to a second size and/or shape at a second end of the gas flow path adjuster further away from the gas flow generation unit. The gas flow path adjuster 210 is configured to adjust the cross section of the gas flow path, for example its size and/or shape, to the cross section of the container carrier or the outer boundary of the container region of the gas flow path. The gas flow path adjuster 210 has a first end facing towards the gas flow generation unit 120 as seen along the gas flow path, the first end having a cross section which is greater than the cross section of a second end of the gas flow path adjuster 210 situated remote from the gas flow generation unit 120 and facing the container unit 140. The gas flow path adjuster 210 has a continuous opening at the first end and/or a continuous opening at the second end. The respective opening may be the only opening of the adjuster at the respective end.

The first end of the gas flow path adjuster 210 is configured to receive the gas flow, e.g. the entire gas flow, originating at the gas flow generation unit 120 and the second end is configured to supply the gas flow towards the container unit 140.

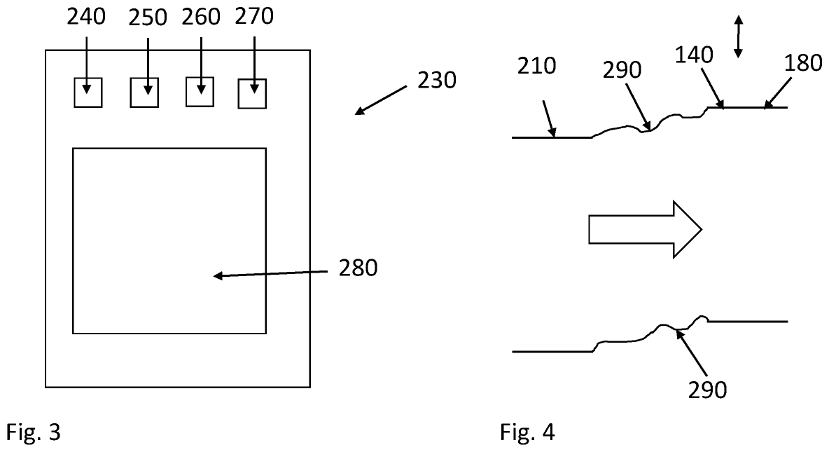

The number of gas deflectors 190 of the gas flow divider 180 may equal the number of container receptacles 150 arranged in stacked fashion above one another, for example arranged in one column of container receptacles 150. A height of the respective gas deflector at an end of the gas flow divider remote from the gas flow generation unit, as seen along the gas flow path, is adjusted to the height of the containers and/or to the height of the container receptacles. Also, as seen along the gas flow path, the gas deflectors 190 widen from the gas flow generation unit towards the container region. In one embodiment of the present disclosure, a respective gas deflector of the plurality of gas deflectors is oriented along, or parallel to, a width direction of the container receptacles and/or along the movement axis of the container unit 140. The gas deflectors 190 are expediently oriented in parallel to one another. The gas deflectors have a triangular cross section, the cross section being taken along the gas flow direction in the gas flow path, when seen from the gas flow generation unit to the container region or container unit 140. A distance between an end of the gas flow divider 180 facing the gas flow path adjuster 210 and an end of the gas flow path adjuster facing the gas flow divider 180 as seen along the gas flow path is less than or equal to one of the following values: 50 cm, 40 cm, 30 cm, 25 cm, 20 cm, 15 cm, 10 cm, 5 cm, 4 cm, 3 cm, 2 cm, 1 cm. The gas flow path is expediently limited laterally or circumferentially by (e.g. circumferentially sealed by) a flexible member (not explicitly shown in FIGS. 1A and 1B, see member 290 in FIG. 3), such as a foil, in a region of the gas flow path between the gas flow generation unit 120 and the container unit 140, e.g. downstream of the gas flow path adjuster 210. The gas flow path adjuster 210 is expediently directly connected to the gas flow divider and/or the flexible member may be fixed to the gas flow path adjuster and to the gas flow divider. The flexible member also allows the movement of the gas flow divider 180 relative to the gas flow path adjuster 210 and delimits the gas flow path. The gas flow divider 180 is movable relative to the gas flow path adjuster 210, in a direction perpendicular to the main extension of the containers, in the width direction of the container receptacles, and/or perpendicular to the (main) extension of the sections of the gas flow path in the container region. The gas flow divider is movable along the end of the gas flow path adjuster facing the gas flow divider as seen along the gas flow path. The gas flow divider and, preferably, the amplitude of the movement of the gas flow divider relative to the gas flow path adjuster, are expediently adjusted to the gas flow path adjuster such that in any relative position of the gas flow divider relative to the gas flow path adjuster, a gas inlet of the gas flow divider covers, preferably completely covers, a gas outlet of the gas flow path adjuster, e.g. the entire outlet. The gas inlet of the gas flow divider is expediently sized so as to be greater than a gas outlet of the gas flow path adjuster. Thus, the divider—although it is moved relative to the adjuster— may collect the entire gas flow at the outlet of the adjuster regard les of the relative position of the divider to the adjuster.

As noted, the container unit 140 is displaceable relative to the gas flow generation unit 120, expediently in a direction perpendicular to the extension of the gas flow path. The movement may be restricted to linear movement e.g. via rails and the chassis 110, or other appropriate guide structures. The container unit may be motor driven and can move back and forth between two extreme positions along one axis, which is schematically shown in FIG. 1B by the double-headed arrow.

The containers 160 may be locked in position within the respective rack or receptacle by the locking member 200 which is, expediently releasable, connectable to the container carrier 155.

The device 100 also comprises a trigger mechanism, such as a switch, to initiate the operation cycle (not explicitly shown in FIGS. 1A and 1B). Further, the device 100 further comprises at least one timer, which, after a predetermined time has elapsed, ends the operation cycle by switching the device off. The time after which the device (or the container unit movement and/or the gas flow generation) is switched off may be fixed or adjustable by the user. The device 100 is configured such that the gas flow generation unit 120 and/or the motor moving the container unit 140 operate during the entire operation cycle of the device. This operation may take place with preset parameters, the parameters being preferably constant during the entire operation cycle or variable. For example, the frequency of the container unit movement may be varied and/or the duration of the operation cycle may be varied, e.g. via the timer.

The device 100 is configured such that the device is capable of thawing the content of 15 containers with a fill volume of more than 10 L and/or less than 20 L (L: Liter(s)) within a predetermined time. The predetermined time is less than or equal to one of: 20 h, 19 h, 18 h, 17 h, 16 h, 15 h, 14 h, 13 h, 12 h, 11 h, 10 h, 9 h, 8 h, 7 h, 6 h. The predetermined time is greater than or equal to one of 4 h, 5 h, 6 h, 7 h, 8 h, 9 h, 10 h. The predetermined time or duration of the operation cycle (or thawing cycle) may be between 4 h and 20 h.

Within the device 100 all the container receptacles 150 may be configured alike. A height of the (respective) container receptacle 150, e.g. defined as the dimension perpendicular to the movement axis of the container carrier and/or perpendicular to the direction of the gas flow path in the container region, is less than a width of the container receptacle, defined as the dimension along the movement axis of the container carrier and/or perpendicular to the direction of the gas flow path in the container region, and/or less than a length of the respective container receptacle, defined as the dimension perpendicular to the movement axis of the container carrier and/or the direction along the gas flow path in the container region. The container receptacles 150 are configured to hold containers 160 with a fill volume of greater than or equal to: 6 L, 7 L, 8 L, 9 L, 10 L, 11 L, 12 L. The container receptacles 150 are configured to hold containers 160 with a fill volume of less than or equal to: 20 L, 19 L, 18 L, 16 L, 15 L, 14 L, 13 L, 12 L. The fill volume of the containers may be between 6 L and 20 L (e.g. 12 L Sartorius FFT bags).

The device 100 is a thawing device, and preferably is a dedicated thawing device, and more precisely a device not configured for freezing, and only designed for thawing. As such, device 100 is free of at least any one of or all of an active heating unit to influence the temperature of the containers in the receptacles, an active cooling unit to influence the temperature of the containers in the receptacles, and a temperature monitoring unit to monitor the temperature of the containers. The device 100 is configured to thaw the frozen equivalent of 160 L of liquid content, e.g. distributed over 15 bags, in less than 13 h, e.g. in less than 12 h or in less than 11 h or in less than 10 h or in less than 9 h, from −50° C. to 15° C. or from −60° C. to 15° C. using ambient air in an air-conditioned room with a set ambient temperature between 18 and 25° C. and a room height of 3 meters, e.g. at least three meters, and a floor space of 3×5 m², e.g. of at least 3×5 m².

The gas moved along the gas flow path by the gas flow generation unit 120 during the operation of the device 100 is exemplarily air, such as ambient air, but may be as well any other gas or fluid that is suitable for accomplishing the goals of the present disclosure.

The device 100 is configured such that the gas flow velocity, e.g. in the sections of the gas flow path between the containers 160, when the containers 160 are arranged in the container receptacles 150 and/or at the gas flow generation unit or the gas flow generation members, is greater than or equal to one of: 1.5 m/s, 1.6 m/s, 1.7 m/s, 1.8 m/s, 1.9 m/s, 2 m/s, 2.5 m/s, 3 m/s, 3.5 m/s, 4 m/s, 4.5 m/s, 5 m/s, 5.5 m/s, 6 m/s, 7 m/s, 8 m/s, 9 m/s, 10 m/s, 10.5 m/s, 11 m/s, 11.5 m/s, 12 m/s. The frozen content of the containers is a medical liquid, such as a pharmaceutical liquid, such as a liquid comprising an active pharmaceutical ingredient, such as an ingredient of a vaccine, such as a Corona virus vaccine. The containers may comprise flexible bags. The gas flow velocity in the sections of the gas flow path between the containers may be less than or equal to one of: 20 m/s, 19 m/s, 18 m/s, 17 m/s, 16 m/s, 15 m/s, 14 m/s, 13 m/s, 12 m/s. The gas flow velocity in the in the sections of the gas flow path between the containers can be between 1.5 m/s and 20 m/s. At the air exit region E, velocities of 11.5 m/s or 12 m/s were measured during operation of a thawing device which was constructed as described herein. The gas flow velocity in the sections between the containers (on account of Bernoulli's law) may be greater than the one at the gas flow generation unit and/or at the respective gas flow generation member.

In the sections of the gas flow path in the container region, the gas flow direction is perpendicular to gravity and/or along a support surface supporting the chassis 180 of the device 100.

The device 100 also comprises one or more locking members 200 configured to lock the containers 160 in the container receptacles 150 against movement relative to the container carrier 155. One locking member is configured to be able to lock containers in different container receptacles, such as in different container receptacles of one column or in different receptacles of two (expediently adjacent) columns. The locking member 200 is releasably connectable to the container carrier. For loading the containers, the locking member(s) may be removed and secured to the container unit 140 after the receptacles have been loaded with containers. The container receptacles 150 are accessible in the remote region or outlet region of the gas flow path such that containers 160 can be loaded into the container receptacles 150 from the outlet or the remote region (e.g. after the locking members 200 have been removed).

The thawing device 100 further has a control unit 220 (see FIG. 1A). The control unit 220 may comprise a controller (not shown, e.g. an electrical or electronic controller) which controls operation of the motor for the movement of the container unit. The control unit may comprise the timer mentioned previously. If the container movement duration and gas flow duration can be set separately, a plurality of timers may be provided with movement or gas flow being terminated when a predetermined container movement time or a predetermined gas flow time has expired. This may assist in optimizing the device performance for different liquids. The control unit may comprise a frequency adjuster or frequency converter for adjusting or setting the frequency of the movement of the container unit 140 relative to the gas flow generation unit 120 or the fans 130, e.g. between 0 and 0.8 Hz or 0 and 1.5 Hz. The timer(s) and the frequency adjuster may be suitable to adjust the device 100 to different substances, which are expected to have different properties and different tolerances with respect to mechanical loads exerted on the substances during the thawing process.

The thawing device further has a control panel 230 (not shown in FIGS. 1 and 2, see FIG. 3). The control panel 230 may be accessible behind a closure or door of the control unit 220. The control panel 230 may include switches or other control members for controlling the operation of the device 100 by the user. In the depicted embodiment, the control panel 230 includes a start or trigger switch 240 to initiate an operation cycle or accelerated thawing procedure. Further, optionally, a timer control member 250 is available to set the duration of the operation cycle, where after the set duration, the gas flow generation and/or container unit movement is stopped. Separate timers or timer control members may be provided for the operation of the gas flow generation unit and the maintenance of the container movement as mentioned. Furthermore, optionally, a frequency control member 260 is provided, e.g. a potentiometer. By means of the frequency control member the frequency for the container unit movement can be selected or adjusted, e.g. continuously (e.g. within the boundaries mentioned above) or the frequency can be chosen from a plurality of predefined values, e.g. to optimize the device for the liquid to be thawed. A safety member 270, e.g. an emergency switch, can be provided, e.g. to immediately switch off the entire device, when the safety member 270 is actuated by the user. Further, a display 280 may be provide, e.g. to display information to the operator or user. The information may include the selected or predefined time for the operation cycle, the remaining time until completion of the operation cycle and/or the selected frequency for the container movement. If the container movement is independent from the gas flow generation, the set and/or remaining times for these procedures may be displayed.

The gas flow produced by the gas flow generation unit 120 may be constant during the operation cycle (if gas flow is not generated via the entire cycle, the flow is expediently constant while the gas flow is generated, of course). Alternatively or additionally, the frequency of the container unit movement may be constant during the operation cycle (if the movement is not generated via the entire cycle, the frequency is expediently constant while the container unit is moved, of course). Preferably, gas flow generation and/or container movement is conducted during the entire operation cycle. This has proven to be particularly efficient for thawing processes.

FIG. 4 shows the flexible member 290 which may be provided in the device as mentioned above, e.g. a foil. The flexible member may guide the gas flow (symbolized by the large arrow) from the gas flow path adjuster 210 to the container unit 140 and/or to the gas flow divider 180. The gas flow divider 180 moves together with the container unit 140 as discussed already and indicated by the double headed arrow in FIG. 4. The flexible member 290 provides guidance for the gas and is being deformed continuously while the container unit 140 moves relative to the gas flow generation unit 120.

The present disclosure is also directed to a system comprising the device 100 in any one of its varieties and feature combinations described through this document, in combination with one or more containers with liquid, e.g. liquid for a thawing operation, and/or one or more dummy containers which are sized and shaped to be inserted into the container receptacles, if the number of containers to be processed by the device in one operation cycle is less than the number of container receptacles available in the device. The dummy containers ensure a uniform thawing process also for only a partly filled thawing device.

The present disclosure is further directed to a method for simultaneously thawing the frozen contents (frozen liquid) of a plurality of containers 160 using the device 100 or the above referred to system, the method comprising at least arranging the containers 160 with frozen content within the container receptacles 150, optionally, arranging dummy containers in any empty container receptacle, initiating gas flow generation via the gas flow generation unit 120 for conducting an operation cycle, optionally, moving the container unit 140 relative to the gas flow generation unit 120 during the operation cycle, maintaining the gas flow and, if applicable, the movement of the container unit 140 for a predetermined time.

The thawing device as proposed above was tested following observed filtration issues during the handling of a commercial batch of drug product, e.g. for Comirnaty. A frozen drug product was thawed using the accelerated thawing device 100, set to varying intensities of mechanical shaking (i.e. the frequencies of the container unit movement was varied). Both the acceleration to the thawing process and the stress imparted to the drug product were affected during the thawing. It was observed that filtration and analytical data positively correlated filterability with shaking frequency during the thawing process. At higher shaking frequencies, an increased subvisible particles count reduced the total filterable material (which is undesirable as valuable pharmaceutical material is lost when the filtering does not work properly, e.g. due to the filter being blocked). There was no significant difference in filterability for material thawed with a frequency of 0.32 Hz or less. No other effect on critical quality attributes could be correlated with the thawing protocol used. Following thawing and filtration all material was within the release specification of the drug product. Based on the observations and to ensure efficient batch processing, frozen drug product is preferably thawed with a shaking frequency of 0.32 Hz.

The compatibility of the bulk drug product with frozen storage in order to significantly increase the flexibility for Fill & Finish for the coordination of the manufacturing network and the delivery to use sites by increasing the hold time from a matter of days (for the non-frozen product) to up to eight weeks has already been demonstrated. To complement this demonstration, a thawing device, such as the thawing device as described above, has been developed. As mentioned above, the thawing device 100 allows for the thawing of up to 15×12 L bags 160 at once, allowing the bags 160 to be thawed in circa 6 hours comparative to the up to 24 hours required for passive thawing of the same bags. This is achieved or assisted by forced convection, using a fan to create an air flow over the bags, and/or by mechanically mixing/shaking the bags, e.g. to homogenize their internal temperature during the thawing process. A potential risk identified for the thawing device 100 is the sensitivity of the drug product to shaking.

It has been observed that that a shaking frequency of 0.75 Hz might exceed the maximum tolerable stress which the Comirnaty drug product can endure or is advisable for a high yield. For tests, using drug product bags from the same manufacturing batch, 3 were passively thawed, filtered and filled without issue, and the remaining 4 bags were then thawed using the thawing device 100. While filtration of the latter 4 bags was possible, it has been observed that flow rate reduced significantly across the filtration process (with approximately 20% of the total input mass being lost as hold up volume within the filter capsule). In order to reduce the impact on filterability, while maintaining rapid thawing times, the shaking frequency has been investigated as a potential variable to influence filterability. Shaking frequencies from 0 to 100% of the originally specified frequency of 0.75 Hz or 0.8 Hz were investigated. The amplitude of the shaking motion was kept constant, with the goal of reducing the acceleration/deceleration for the liquid within the bag. Upon screening of the thawing times and foam formation of the test material within the bag (the more foam there is, the lower the filterability might be), it was determined that <60% of the original shaking frequency should be tested further. To test the effect of the modified thawing process on the quality of the drug product, the material was thawed both passively and using the thawing device 100. All samples have been filtered and compared as a function of filterability and critical quality attributes. Ideally, by properly reducing the shaking frequency of the thawing device 100, the filterability of the drug product will remain comparable to that of a passively thawed drug product.

For further test purposes, eight (8) drug product bags containing 11 to 12 L of drug product were made available and stored at −60 to −80° C. until the start of the experiment. The first 2 bags were thawed passively at room temperature (20-25° C.) for a duration of 16 to 24 hours. Thawing was stopped when all ice was melted or when a temperature of 2° C. was observed. The remaining bags were loaded into the accelerated thawing device 100 and thawed at the shaking frequency and duration of:
Bag 1 and 2: Passive (unassisted) thawing, for 16-24 hours
Bag 3 and 4: Active thawing, at a shaking frequency set to 60% (0.48 Hz) of the originally envisaged frequency (0.75 Hz or 0.8 Hz) using an associated potentiometer setting, for 6 hours and 30 minutes
Bag 5 and 6: Active thawing, shaking frequency set to 40% (0.32 Hz) of the originally envisaged frequency (0.75 Hz or 0.8 Hz) at an associated potentiometer setting, for 7 hours and 30 minutes.

The shaking frequency was adjusted via a potentiometer on the control panel (frequency control member). There may be 10 graduations on the dial of the potentiometer, each corresponding to a 10% increase in shaking frequency such that 100% corresponds to 0.8 Hz and 0% corresponds to 0 Hz. The settings used for the tests were 4 and 6 on this dial (i.e. 40% and 60%). There are 2 additional timer switches also present on the thawing unit's control panel, these controlling the operating periods for the fans and the shaking unit respectively. An additional time period was added to the minimum thawing time to compensate for the reduced shaking of each of the groups. This was approximated as 30 minutes for each 10% reduction in shaking frequency, thus for a shaking frequency of 40%, the calculated thawing time should be

$$[ 262 minutes + ( 6 \times 30 minutes ) ] = 442 minutes = 7 hrs 22 minutes \approx 7 hrs 30 minutes$$

Further to the time calculation above, during the thawing experiment, empty drug product bags 160 were used to block the empty slots of the thawing device 100 so as to ensure a homogeneous air flow across all bags within the device 100.

For filtration experiments, the down scaled filter, the Sartopore® 2 Capsule (5441307H4-SS-B) was used. This model has a surface area of 150 cm\hat{ }2 surface˜=0.147 L/cm\hat{ }2 for an approximate 22 L of BDP within 2 standard filled bags, which is equivalent to more than 10 fold the filtration ratio of a commercial batch 0.013 L/cm\hat{ }2; this design permits the approximation of the factor of safety inherent to the filter size relative to the batch volume of BDP to be filtered.

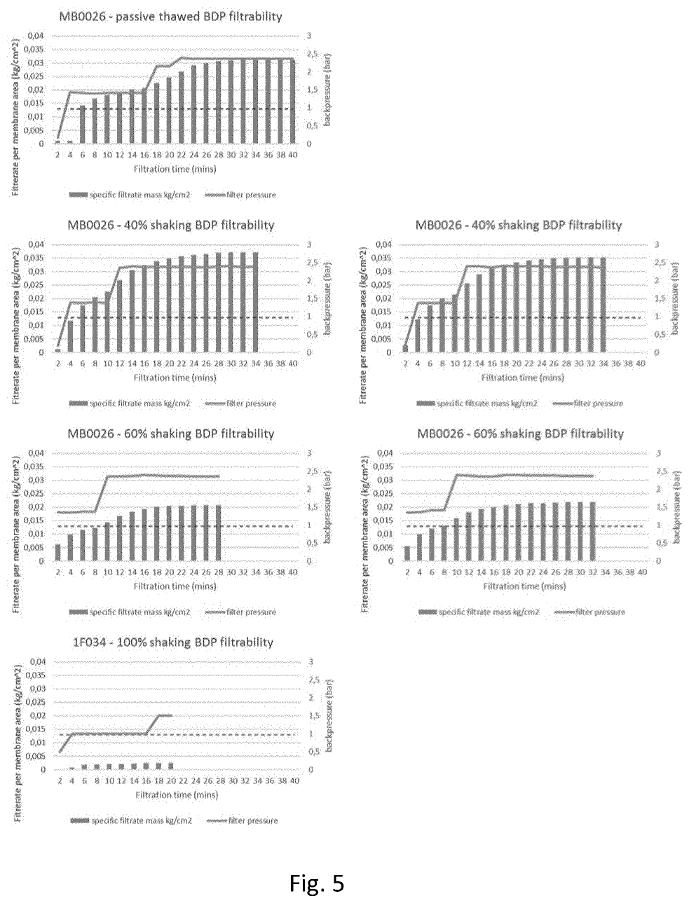

Following the thawing process, pooling of the bags was done. Prefiltration samples from each of the 3 groups (40%, 60% shaking and passive thawing, i.e. no shaking or frequency 0 Hz) were taken and frozen to below −60° C. Once the drug product was normalized to above 20° C., the drug product was then filtered. For this, it was pumped through the filter capsule at room temperature (19-21° C.). The filtration pressure started from 0.2 bar and was ramped up to 1.4 bar. In the event of filter clogging, the operator waited on the plateau for short time (5 minutes approx.), and then ramped up to maximum of 2.4 bar to see if through flow could be maintained. The time, pressure and mass flow was noted throughout this experiment. Post filtration samples were taken in an identical sampling protocol and, similarly, frozen to −60° C. As already stated, the potential for further optimization of the shaking frequency of the accelerated thawing device was identified when a drug product batch caused a filter blockage at a low (circa 27 L) volume of throughput with an additionally high hold up-volume. Since additional mechanical stress may be the leading cause for post-thaw filter blockage, 3 thawing events were performed at shaking frequencies of 0 (passive thawing), 0.32 and 0.48 Hz. This material was filtered in 5 filtration events through a lab scale filter with a surface area of 150 cm². The filtration data created with this was then resolved to mass of filtrate per filter membrane area (kg/cm⁻²) in order to directly compare with the data from the associated commercial drug product batch. There is a marked increase in filter back pressure and the reduction in filter throughput as the shaking frequency of the thawing protocol or operation cycle is increased (see FIG. 5 which presents a variety of results). For the passively thawed drug product at 0 Hz, there is both a significant factor of safety between the minimum throughput per membrane area as well as the total filter throughput; this ensures that routine filtrations should not encounter blockages. Furthermore, it was observed that frozen drug product may be subjected to a shaking frequency of up to 0.48 Hz without a significant effect being observable in a theoretical commercial filtration scenario, ergo, the complete 160 kg or 160 L of drug product which can be thawed simultaneously (15×12 L=160 L) would be filtered while still at constant pressure. Therefore, the shaking frequency used in the accelerated thawing protocol can or should be kept at a set point of 0.32 Hz and/or below the approximated batch filterability limit of 0.48 Hz so as to ensure that there is always some filter redundancy.

Prior to the filtration experiments presented above, initial screening of the thawing time of a fully loaded thawing device at shaking frequencies of 0 to 0.8 Hz indicated that, for a fully laden rack (15 bags), at an ambient temperature of 18° C., thawing time decreases by about 31 to 35 minutes for each 0.08 Hz increase in shaking frequency leading thawing durations to vary from 11 hours, when the bags are placed without any mechanical movement in the path of the air flow, to 6 hours, when the bags are shaken at 0.8 Hz for the duration of the thawing process. This sizeable difference in performance is further influenced when one considers the additional variable of number of filled bags within a thawing event; this may vary from 1 to 15 for the device depicted in FIGS. 1A and 1B.

It is noted that the above summarized device and configurations exhibit a plurality of advantages versus other arrangements investigated with respect to a thawing process for a plurality of bags. The effect of the orientation and geometry of the bag relative to the air flow was investigated taking into consideration various geometries of the single bag, such as the horizontal bag with airflow to the narrow side, the horizontal bag with airflow to the broad side, the vertical bag with airflow to the narrow side, the vertical bag with the airflow to the broad side, the vertical bag with the frontal airflow, and the effect of stacking the bags was also investigated, such as stacked bags with one gap between bags, and stacked bags with one gap of varying height between 2 bags. Of all geometries tested for the single bag, at all air flow rates, the geometry of the single vertical bag with frontal airflow proved to be most efficient in terms of thawing. This corresponds to an arrangement in which the bag is oriented perpendicular to the air flow, which provides the largest contact area surface for heat transfer between the frozen liquid and the air to take place. Therefore, if the thawing of a single bag should be required, it may be accelerated by placing the bag in the path of a steady air flow, the faster the air velocity, the better. Exemplarily, the bag is placed in a laminar flow hood directly on the outlet grating.

However, for a plurality of bags (which may be the most important use case), the most efficient heat transfer or heat transfer coefficient was produced by the geometry in which stacked bags with a gap between the bags were investigated. The stacked bags create enclosed channels above and below each bag which serve to focus or assist in focusing air flow onto the bag surfaces, thus resulting in a 50 to 60% increase for the heat transfer coefficient, especially at air flow rates above 1 m/s. But, in this configuration, the increased heat transfer may result in a disproportionate backpressure at the fan and a corresponding pressure drop across the bag length which is required to force sufficient air into the narrow spacing between the stacked bags. This pressure drop can, however be notably reduced, without an equivalent loss in heat transfer rate, when the spacing between the bags (the channel width of the air flow channel) is chosen to be between 1 to 5 cm. In this case, variation in distance between two bags was tested relative to the height of an already existing stacking system, that of the Sartorius® Bulk Shipper. The observed decrease in back pressure would facilitate greater homogeneity of air distribution within these bag-to-bag channels while simultaneously reducing the load on the fan, thus increasing the expected working lifespan of the device.

The thawing behavior for a plurality of bags has been investigated for a variety of settings using the Thermowell version of the FFT bags with appropriately placed temperature sensors. Three sensors were used per bag to measure the current temperature within the bag at the respective sensor location. FIGS. 6A to 6D show the result of the measurements for 10 bags which were provided in two stacks of five bags arranged besides one another. Sensors T1 to T30 were inside the bags of the two stacks and the associated temperatures are plotted over time.

FIG. 6A shows the thawing progress in a room with 20 to 25° C. room temperature without forced convection of ambient air and without bag agitation/container unit movement. The stacks were provided by Sartorius® Bulk Shippers. Here, even after 72 hours, not all of the bags of the Sartorius Bulk Shipper have reached a temperature of 15° C.

FIG. 6B shows the thawing progress in a room with 20 to 25° C. room temperature with forced convection and container agitation (with a frequency of 0.75 Hz for the oscillating movement between extreme positions separated by 4 cm) in the Sartorius Bulk Shipper (note that this configuration does not have particular gas flow path sections defined in the container region (i.e. the stack of bags)). The generated gas flow had a velocity of 5 m/s at the gas flow source (i.e. at the fan(s)). In this case, the last bag reaches 15° C. at about 16.5 to 17 hours.

FIG. 6C illustrates the thawing progress with forced convection of ambient air in a room with 20 to 25° C. room temperature and container agitation (e.g. with a frequency of 0.75 Hz for the oscillating movement between extreme positions separated by 4 cm) in a dedicated rack arrangement with gas flow path sections or channels formed between adjacent bags of one stack (with otherwise an identical configuration as in FIG. 6B). The channels had a height and/or width between 1 and 5 cm. The generated gas flow had a velocity of 1.2 m/s at the gas flow source (i.e. at the fan(s)). As can be seen, although the gas is driven with far lower velocity than in the scenario of FIG. 6B (1.2 m/s vs. 5 m/s), the thawing time to 15° C. is comparable hinting to a higher efficiency of the thawing process in the FIG. 6C scenario. The last bag reaches 15° C. at about 17.5 hours. This suggests that air flow along the exterior of the containers in channels between adjacent containers accelerates the thawing process.

FIG. 6D shows the scenario of FIG. 6C with the gas flow velocity of 5 m/s at the source. The last bag reaches 15° C. at about 7.5 hours, i.e. the thawing time has been reduced drastically. This suggests that velocities of greater than 1.2 m/s accelerate the thawing process.

These results formed the basis of the design of the thawing device described above in more detail. Further optimizations, e.g. with respect to the number of fans used for air flow generation, resulted in the device described above.

Thus, movement of the container unit especially in combination with forced convection (via the gas flow generation unit 120) can drastically reduce the thawing time. These results were the basis for the considerations in the development of the thawing device which has been described further above and, expediently, may also apply to this device.

FIGS. 7A and 7B illustrate various views of another embodiment of the thawing device 100. The device 100 is configured as and operates according to the previously described device, but the control unit may not protrude as pronounced from the chassis as in the previously described device. Hence, all of the features which have been described previously also apply for this device and vice versa. Further, in the figures, the motor 300 is shown, which can move the container unit 140 linearly.

In summary, it has been discovered that the thawing device as described above is particularly suitable for accelerating the simultaneous thawing of frozen liquid substances in a plurality of containers, particularly biopharmaceutical substances.

This patent application claims the priority of European patent application EP 21 176 087.1 filed on May 26, 2021, the entire disclosure content of which is herewith included into the present application for all purposes.

### REFERENCE NUMERALS

100 device
110 chassis
120 gas flow generation unit
130 fan
140 container unit
145 container unit base
150 container receptacle
155 container carrier
160 container
170 container gas duct
180 gas flow divider
190 gas deflector
200 locking member
210 gas flow path adjuster
220 control unit
230 control panel
240 start switch
250 timer control member
260 frequency control member
270 safety member
280 display
290 flexible member295 feet
300 motor
E air exit region

1. A device (100) for thawing a content of one or a plurality of containers (160), wherein the content comprises a frozen liquid, the device (100) comprising:
a container unit (140), the container unit (140) comprising a container carrier (155),
wherein the container carrier (155) has or comprises one or more container receptacles (150), each container receptacle (150) being suitable to receive one container (160) with the frozen liquid; and
a gas flow generation unit (120),
wherein the gas flow generation unit (120) is operable to generate a gas flow along a gas flow path defined in the device (100),
wherein the device (100), in the region of the container carrier (155), is configured to define a container region of the gas flow path,
wherein, in the container region of the gas flow path, a section of the gas flow path extends along the exterior of the respective container (160) when the respective container (160) is arranged in the container receptacle (150), and
wherein the container unit (140) is movable relative to the gas flow generation unit (120).

2. The device (100) of claim 1,
wherein the device (100) is configured to move the container unit (140) between two extreme positions relative the gas flow generation unit (120) in an oscillating manner.

3. The device (100) of any one of the preceding claims,
wherein the container carrier (155) comprises a plurality of rows of container receptacles (155) and a plurality of columns of container receptacles (155), wherein each row of container receptacles (155) and each column of container receptacles (155) comprises a plurality of container receptacles.

4. The device (100) of any one of the preceding claims,
wherein between two vertically or laterally adjacent container receptacles (150) one section of the gas flow path in the container region of the gas flow path is formed between the containers (160), when the containers (160) are arranged in the two adjacent container receptacles (150).

5. The device (100) of any one of the preceding claims,
wherein each container (160), when in the container receptacle (150), is sandwiched between two sections of the gas flow path.

6. The device (100) of any one of the preceding claims,
wherein the device (100) further comprises a chassis (110), wherein the container carrier (155) is connected to the chassis (110), wherein the gas flow generation unit (120) is fixedly connected to the chassis (110).

7. The device (100) of any one of the preceding claims,
wherein a main gas flow direction in the sections of the gas flow path in the container region is oriented along a main extension direction of the containers (160), when the containers (160) are received in the respective container receptacle (150).

8. The device (100) of any one of the preceding claims,
wherein the gas flow generation unit (120) comprises one or a plurality of movable gas flow generation members (130), wherein each of the gas flow generation members is operable to generate a gas flow which contributes to the total gas flow along the gas flow path.

9. The device (100) of claim 8,
wherein the gas flow generation members (130) are linearly arranged in a one dimensional arrangement.

10. The device (100) of claim 8 or 9 with additional reference to claim 3,
wherein different gas flow generation members (130) are assigned to different columns of container receptacles (150).

11. The device (100) of any one of claims 8 to 10,
wherein the movable gas flow generation members (130) are arranged to generate gas flows in parallel directions.

12. The (100) device of any one of claims 8 to 11,
wherein the gas flow generation members (130) comprise fans.

13. The device (100) of any one of the preceding claims,
wherein the gas flow generation unit (120) is configured to generate a gas flow with a gas flow velocity of greater than or equal to one of 1.0 m/s and of less than or equal to 8 m/s or of greater than or equal to 1.2 m/s and of less than or equal to 8 m/s.

14. The device (100) of any one of the preceding claims,
wherein the gas flow generation unit (120) is configured to provide a total gas displacement of greater than or equal to 9000 m³/h and less than or equal to 21000 m³/h.

15. The device (100) of any one of the preceding claims,
wherein the gas flow generation unit (120) is configured to displace the gas along the gas flow path towards the container region in a blowing mode of operation of the gas flow generation unit (120).

16. The device (100) of any one of the preceding claims,
wherein the device comprises one or more gas inlets and one or more gas outlets, the gas flow path extending from the gas inlets to the gas outlets and/or fluidly connecting the gas inlets and the gas outlets, and wherein the gas inlet of the device (100) is or the gas inlets of the device (100) are defined by the gas flow generation unit (120).

17. The device (100) of any one of the preceding claims,
wherein the device comprises a chassis (110), wherein the container carrier (155) is connected to the chassis, and wherein the container unit (140) is linearly movable relative to the chassis (110) and/or the gas flow generation unit (120).

18. The device (100) of claim 17,
wherein the container unit (140) is connected to the chassis (110) such that movement of the container unit (140) relative to the chassis is restricted to linear movement along a movement axis, wherein the container unit (140) is movable along the movement axis in opposite directions, wherein the movement axis is fixed relative to the chassis (110) and/or relative to the gas flow generation unit (120), and wherein the movement axis of the linear movement of the container unit (140) is perpendicular to the gas flow path in the container region and/or perpendicular to the main longitudinal direction of extension of the containers (160).

19. The device (100) of any one of the preceding claims with additional reference to claim 2, wherein the device (100) is configured such that a frequency of the oscillating movement of the container unit (140) between the two extreme positions is less than or equal to 1.5 Hz and greater than or equal to 0.01 Hz.

20. The device (100) of any one of the preceding claims,
wherein the container unit (140) comprises a container gas duct (170), the container gas duct (170) delimiting the gas flow path laterally or circumferentially in the container region, and wherein, in the container region, an exterior surface of a container in cooperation with the inner wall of the container gas duct (170) delimits a section of the gas flow path.

21. The device (100) of claim 20,
wherein, in the region of the container unit (140), the gas flow path defined in the device (100) is restricted to the container unit (140) by the container gas duct (170).

22. The device (100) of any one of the preceding claims,
wherein the device comprises a gas flow path adjuster (210), and wherein the gas flow path adjuster (210) is arranged to define and/or to focus the gas flow path in an intermediate region of the gas flow path between the gas flow generation unit (120) and the container unit (140).

23. The device (100) of claim 22,
wherein the gas flow path adjuster (210) is configured to change the size and/or shape of the cross section of the gas flow path from a first size and/or shape at a first end of the gas flow path adjuster closer to the gas flow generation unit as seen along the gas flow path to a second size and/or shape at a second end of the gas flow path adjuster (210) further away from the gas flow generation unit (120), and wherein the first end of the gas flow path adjuster (210) is configured to receive the gas flow originating at the gas flow generation unit (120) and the second end is configured to supply the gas flow towards the container unit (140).

24. The device of claim 22 or 23,
wherein the gas flow path adjuster (210) is configured to adjust the cross section of the gas flow path to the cross section of the container carrier or the outer boundary of the container region of the gas flow path.

25. The device (100) of claim 23 or 24,
wherein the gas flow path adjuster (210) has a continuous opening at the first end and/or a continuous opening at the second end.

26. The device (100) of any one of the preceding claims,
wherein the device comprises a gas flow divider (180), and wherein the gas flow divider (180) is arranged between the gas flow generation unit (120) and the container region as seen along the gas flow path.

27. The device (100) of claim 26,
wherein the container unit (140) comprises the gas flow divider (180).

28. The device (100) of claim 26 or 27,
wherein the gas flow divider (180) is configured to direct incoming gas flow into the sections of the gas flow path in the container region.

29. The device (100) of claim 28,
wherein the sections are adjusted to the positions of the container receptacles (150) relative to the gas flow divider (180), such that each container (160) has at least one section of the gas flow path extending over opposite surfaces of the container.

30. The device (100) of any one of the preceding claims,
wherein the gas flow path is limited laterally by a flexible member (290) in a region of the gas flow path between the gas flow generation unit (120) and the container unit (140).

31. The device (100) of claim 30 with additional reference to claim 22 or any other claim when referring to claim 22,
wherein the region directly connects the gas flow path adjuster (210) to the gas flow divider (180), wherein the flexible member (290) is fixed to the gas flow path adjuster and to the gas flow divider, and wherein the flexible member allows movement of the gas flow divider (180) relative to the gas flow path adjuster (210).

32. The device (100) of any one of the preceding claims,
wherein the device (100) is configured such that the device (100) is capable of thawing the content of 15 containers with a fill volume of more than 10 L and/or less than 20 L within a predetermined time, wherein the predetermined time is less than or equal to 20 h and greater than or equal to 4 h.

33. The device (100) of any one of the preceding claims,
wherein the device (100) is configured to thaw the frozen equivalent of 160 L of liquid content, e.g. distributed over 15 containers (160), in less than 13 h, e.g. in less than 12 h or in less than 11 h or in less than 10 h or in less than 9 h, from −50° C. to 15° C. or from −60° C. to 15° C. using ambient air in an air-conditioned room with a set ambient temperature between 18 and 25° C. and a room height of 3 meters, e.g. at least three meters, and a floor space of 3×5 m², e.g. of at least 3×5 m².

34. The device (100) of any one of the preceding claims,
wherein the frozen content of the respective container (160) is a medical liquid.

35. The device (100) of any one of the preceding claims with additional reference to claim 2, wherein the distance of the oscillating movement of the container unit (140) from one extreme position to the other extreme position is greater than or equal to 2 cm and less than or equal to 6 cm.

36. A system, comprising:
the device (100) of any one of the preceding claims and
a) one or more containers (160) with liquid, e.g. liquid for a thawing operation, and/or
b) one or more dummy containers which are sized and shaped to be inserted into the container receptacles, e.g. if the number of containers to be processed by the device in one operation cycle is less than the number of container receptacles available in the device.

37. A method for simultaneously thawing the frozen contents of a plurality of containers (160) using the device (100) or a system of any one of the preceding claims comprising the following steps:
arranging the containers (160) with frozen content within the container receptacles (150),
optionally arranging dummy containers in any empty container receptacle (150),
initiating gas flow generation via the gas flow generation unit (120) for conducting an operation cycle,
moving the container unit (140) relative to the gas flow generation unit (120) during the operation cycle,
maintaining the gas flow and/or the container unit movement for a predetermined time.
